(19) United States
(12) Patent Application Publication
(10) Pub. No.: US 2025/0307220 A1
(43) Pub. Date: Oct. 2, 2025

(54) Sending Contextual Data on Dataflows of Dataflow Graphs

(71) Applicant: Ab Initio Technology LLC, Lexington, MA (US)

(72) Inventors: Aaron Epstein, Lexington, MA (US); Frank Lynch, Concord, MA (US); Stephen Schmidt, Medford, MA (US)

(21) Appl. No.: 18/796,730

(22) Filed: Aug. 7, 2024

Related U.S. Application Data
(60) Provisional application No. 63/572,761, filed on Apr. 1, 2024.

(51) Int. Cl. G06F 16/22

(52) U.S. Cl. CPC G06F 16/22

(57) ABSTRACT

A method implemented by a data processing system for processing records with a dataflow graph that includes transmitting the records over a dataflow of the dataflow graph and transmitting, among the records, information, associated with the processing of the records, over the same dataflow without modifying the records. The information can include trace data describing how the records are being processed.

### CLAIM OF PRIORITY

This application claims priority under 35 U.S.C. § 119(e) to U.S. Patent Application Ser. No. 63/572,761, filed on Apr. 1, 2024, the entire contents of which are hereby incorporated by reference.

### TECHNICAL FIELD

This disclosure relates to techniques for efficiently operating a data processing system with many datasets that may be stored in any of a large number of data stores.

### BACKGROUND

Modern data processing systems manage vast amounts of data within an enterprise. A large institution, for example, may have millions of datasets. These datasets can support multiple aspects of the operation of the enterprise. Complex data processing systems typically process data in multiple stages, with the results produced by one stage being fed into the next stage.

To support a wide range of functions, a data processing system may execute applications, whether to implement routine processes or to extract insights from the datasets. The applications may be programmed to access the data stores to read and write data.

As described in “Tracing Distributed Data Stream Processing Systems,” FIG. 1A shows “records traced through tasks, each consisting of a shuffle read, a UDF pipeline and a shuffle write phase . . . invoked over [a] wrapped record.” FIG. 1B is an annotated version of FIG. 1A.

### SUMMARY

The systems and methods described herein are configured for processing records with an executable dataflow graph by transmitting the records over a dataflow of the dataflow graph and by transmitting, among the records, information, associated with the processing of the records, over the same dataflow without modifying the records. The information transmitted among the records over the data flow can include trace data describing how nodes of the data flow graph processed the data records. The information can include other metadata describing either processing of the records or assisting the processing of the records by the nodes of the data flow graph. For example, this metadata can include data specifying an address of a service call, one or more data processing parameters used (e.g. by a node) to define a portion of a node's processing of a given record among the records, diagnostic information such as about data processing performance of one or more nodes processing the data records, or other such data that is not to be included in the records themselves. In some examples, the information is called context data.

The systems and methods described herein enable a computer program or application including an executable data flow graph to transmit context data between nodes of the data flow graph and among the records without requiring any modification to the records to include the context data. Additionally, modifications to the components of the data flow graph to process the context data are avoided. Rather, the system described herein processes the context data in a way that is hidden, such as from the user. The data processing system itself can identify the context data from among the records and use the context data for processing the records and/or update the context data based on processing the records without requiring modifications to each individual component of the data flow graph to process the context data. For example, there is no need to add additional data flows to transmit the context data between nodes of the data flow graph. The context data are transmitted from a first node to a second node on a same data flow as the data records that the context data describe. This is also helpful to maintain context. The context data takes the same data processing path as the data records.

The systems and methods herein send, on a data flow, the context data among the data records by sending a particular item of context data on the data flow in proximity to a data record associated with that item of context data. A data processing system is configured to receive implicit data records that are interleaved with data records associated with those implicit data records. An implicit data record includes an item of data including information describing the data records but not having the structure of fields and values that are included in the data records. Specifically, an implicit data record includes data that may be unstructured and which a component processing the data records identifies as metadata among the data records. The implicit data record can include an identifier specifying with which data record it is associated.

A data processing system identifies which component is currently being executed. A set of data records are received for processing by the component. The set of data records are stored in a buffer, and the data processing system executes the component to process each record. Implicit data records received among the data records are stored in a separate buffer from the data records. When a record is to be processed by the component, the data processing system checks the buffer including the implicit data records to determine whether an implicit data record exists for that particular data record to be processed. If an implicit data record exists for that particular record, the implicit data record is retrieved from the buffer and stored in the runtime environment for modification during processing of the record. If there is no implicit data record in the implicit record data buffer associated with the record to be processed, the data processing system can either generate a new implicit data record for that particular record or process the record without generating an implicit data record based on instructions received for processing the set of records. Specifically, not all data records have an implicit data record associated with them, and not all data records require an implicit data record including context data to be generated during processing of those data records. For example, if performing distributed tracing in a data flow graph, only a small percentage of the set of data records may be traced to improve the efficiency and reduce the latency of processing the set of data records. For example, one in one hundred data records can be associated with context data of an implicit data record. For distributed tracing, not all data records need trace data, over thousands of processed records, to diagnose any issues that may be occurring during the processing of the set of data records. The systems and methods described herein enable the data processing system to identify which record among the set of data records is associated with trace data and modify that trace data as the data record is processed through each of the components of the data flow graph to illustrate how the data flow graph is processing the records at each component.

The systems and methods described herein enable one or more advantages. The systems and methods described herein enable increased flexibility for data flow graphs. The context data can be transmitted over a same structure of the data flow graph as the data records to quite effectively maintain the context for the records as specified in the context data. The context data can be modified without having to modify the structure of the data flow graph such as adding additional data flows or modifying the data records to include the context data. This allows to modify a legacy system to include and/or activate additional functionality without having to modify an application for processing data records or change how the data records are structured. That is, inactive functionality can be activated and/or newly available functionality can be integrated into the application effectively and efficiently. Downtime of the data processing system can be reduced for the activating and/or incorporating of the respective functionality. For example, distributed tracing can be added for different records processed by a data flow graph without having to add fields to the data records to include trace data and without having to add additional data flows for sending the trace data between the nodes. Rather, each component can automatically handle trace data that it receives in a distinct way from the data records it receives by identifying which data includes trace data and modifying the trace data based on how the data records that trace data is describing are processed. In another example, metadata that describes the data records and/or parameter values of the components can be transmitted with the data records through the data flow graph without the need to update the logic of components within the data flow graph. That is, the metadata can define the data processing functionalities to be applied by a component to the records associated with the metadata. This enables more efficient processing of large amounts of data. For example, metadata that is used for processing the data records can be sent with the data records without having to specify that this metadata is distinct from the data records. In this example, metadata that describes a source for a service call can be sent with data records for which the service call is made by the component of a graph. The address of the service call does not need to be stored within the records.

The systems and methods described herein enable context data to remain associated with particular data records even when the data records are processed by a networked system of data processing systems. For example, when executing the logic of a data flow graph, a parallelized system may include many data processing systems each configured to execute portions of the data flow graph. In another example, a set of data processing systems may be distributed on a networked system such that the set of data records may be transmitted between different systems of the networked system for processing the records using the data flow graph. The systems and methods herein enable context data for a particular record to remain associated with that particular record when the record is transmitted among different data processing systems of the networked system.

One or more of the advantages previously described can be enabled by one or more of the following embodiments.

In an aspect, a method implemented by a data processing system for processing records with an executable dataflow graph by transmitting the records over a dataflow of the dataflow graph and by transmitting, among the records, information, associated with the processing of the records, over the same dataflow without modifying the records, includes accessing, by the data processing system, the dataflow graph having nodes and edges, with each node specifying computer-executable code for executing one or more processes and with each edge specifying dataflow between two or more of the nodes, wherein a first node of the nodes is configured to transmit data to a second node of the nodes; processing, by the first node of the dataflow graph, a record in accordance with a process specified by computer-executable code specified by the first node; based on the processing, producing, by the first node, a processed record to be transmitted to the second node, wherein the first node is configured to transmit records in an order to the second node, with the processed record being at a location in the order; based on the processing, identifying, by the first node, information associated with processing of the processed record; associating, by the first node, the identified information with the processed record by: determining a value specifying the location of the processed record in the order; and updating the identified information with the value; and transmitting, by the first node to the second node, a plurality of records including the processed record in the specified location in the order and the updated information among the records in the plurality, by, for each of the records: identifying a location of the record among the records in the plurality; determining whether the record is the processed record associated with the updated information by determining whether the identified location corresponds to the value, specifying the location of the processed record, in the updated information; and when the identified location corresponds to the value in the updated information, transmitting, over a dataflow specified by an edge from the first node to the second node, the record to the second node at the location in the order; and transmitting, over the same dataflow to the second node, the updated information in proximity to the transmitted record.

In some implementations that can include any of the foregoing implementations, the method includes receiving, at the first node, a set of records to be processed; storing in a first buffer, for the set of records, a set of data items, a data item of the set of data items including information associated with a record of the set of records, the data item of the set of data items including a count indicating the record associated with the data item; and storing the set of records in a second buffer.

In some implementations that can include one or more of the foregoing implementations, the method includes, for processing a particular record of the set of records: determining, for the particular record, whether a data item in the first buffer includes a particular count that associates the data item with the particular record; and when the first buffer includes the data item having the particular count associated with the particular record, processing the particular record by the first node, and updating the data item based on processing the particular record by the first node; and when the first buffer does not include the data item having the particular count associated with the particular record, processing the particular record by the first node, and generating a new data item based on processing the particular record by the first node for being associated with the particular record.

In some implementations that can include one or more of the foregoing implementations, the method includes storing, at a first output buffer, the processed record among a set of output records; determining an output order count for the processed record for being output among the set of output records; associating the updated information with the output order count for the processed record; and storing, a at second output buffer, the updated information and the output order count among other updated information for other output records.

In some implementations that can include one or more of the foregoing implementations, transmitting, over the same dataflow to the second node, the updated information in proximity to the processed record includes transmitting the updated information based on the output order count associated with the updated information.

In some implementations that can include one or more of the foregoing implementations, transmitting, over the same dataflow to the second node, the updated information in proximity to the transmitted record comprises transmitting the updated information immediately prior to the transmitted record on the same dataflow.

In some implementations that can include one or more of the foregoing implementations, transmitting, over the same dataflow to the second node, the updated information in proximity to the transmitted record comprises transmitting the updated information immediately subsequent to the transmitted record on the same dataflow.

In some implementations that can include one or more of the foregoing implementations, the method includes determining that the second node of the dataflow graph is a final node of the dataflow graph without additional nodes; and transmitting the updated information to a publisher system.

In some implementations that can include one or more of the foregoing implementations, the method includes determining that the second node of the dataflow graph is a final node of the dataflow graph without additional nodes; and storing the plurality of records in a data store.

In some implementations that can include one or more of the foregoing implementations, the updated information is interleaved within the records of the plurality such that the updated information is transmitted in the dataflow between two consecutive data records.

In some implementations that can include one or more of the foregoing implementations, the updated information associated with the processed record includes trace data describing how the first node processed the processed record.

In some implementations that can include one or more of the foregoing implementations, the updated information associated with the processed record includes metadata describing a location for a service call by one or more nodes of the dataflow graph.

In some implementations that can include one or more of the foregoing implementations, the second node is configured to receive additional records from a third node over a different dataflow and additional information associated with the additional records over the different dataflow.

In some implementations that can include one or more of the foregoing implementations, the second node selects either the additional information or the updated information for associating with processed records of the third node.

In some implementations that can include one or more of the foregoing implementations, the second node selects both the additional information and the updated information for associating with processed records of the third node.

In some implementations that can include one or more of the foregoing implementations, the processing, by the first node of the dataflow graph, of the record in accordance with the process specified by computer-executable code encapsulated by the first node is performed to obtain the processed record.

In some implementations that can include one or more of the foregoing implementations, the updated information associated with the processed record includes one or more values specifying one or more data processing parameters to be used by the second node for defining a portion of processing, by the second node, of the processed record.

In some implementations that can include one or more of the foregoing implementations, the updated information associated with the processed record includes diagnostic information indicating a performance metric of the first node when processing the processed data record.

In some implementations that can include one or more of the foregoing implementations, the method includes processing, by the second node of the dataflow graph, the transmitted processed record in accordance with a process specified by computer-executable code specified by the second node, wherein, as the second node processes the processed data record, the second node reads parameter values from the transmitted updated information for processing the processed data record in accordance with the read parameter values.

In some implementations that can include one or more of the foregoing implementations, the method includes updating the information associated with the processed record in accordance with the processing of the processed record by the second node.

In some implementations that can include one or more of the foregoing implementations, the information updated in accordance with the processing of the processed record by the second node specifies a time of processing of the processed record at the second node and/or identifies the second node as the last node that processed the processed record.

In an embodiment, a data processing system includes a memory and one or more processors for performing operations of the foregoing methods.

In an embodiment, one or more non-transitory computer-readable hardware storage devices store instructions that, when executed by one or more processors, enable the one or more processors for performing operations of the foregoing methods.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1A-1B are each a block diagram illustrating a system.

FIGS. 1C-1F are each block diagrams illustrating a data processing system configured for sending contextual data on dataflows of dataflow graphs.

FIGS. 2A and 2B are each block diagrams illustrating a data processing system configured for sending contextual data on dataflows of dataflow graphs.

FIGS. 3A to 3K are each block diagrams illustrating a data processing system configured for sending contextual data on dataflows of dataflow graphs.

FIGS. 4A-4D are block diagrams illustrating a data processing system for performing tracing.

FIGS. 5A-C are block diagrams illustrating an example system.

FIG. 6 illustrates an example process.

FIG. 7 is a diagram illustrating details of a computer system, such as a data processing system.

### DETAILED DESCRIPTION

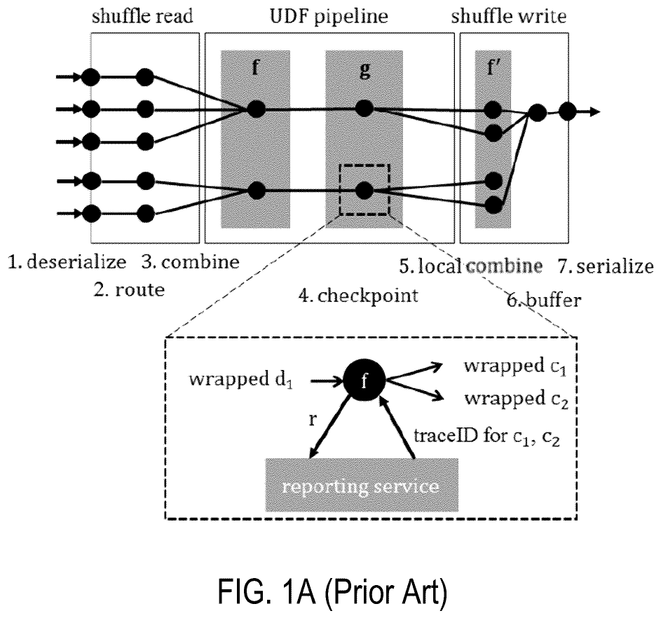

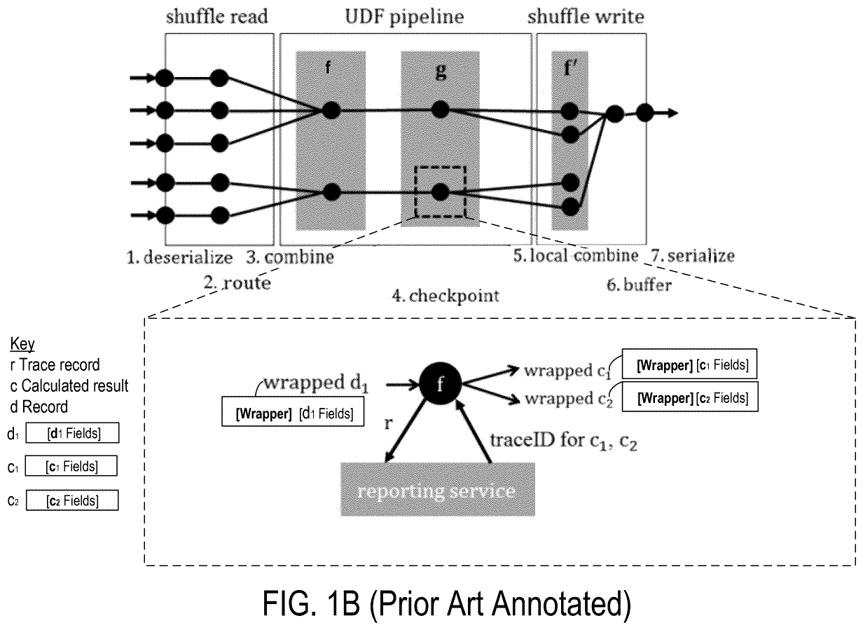

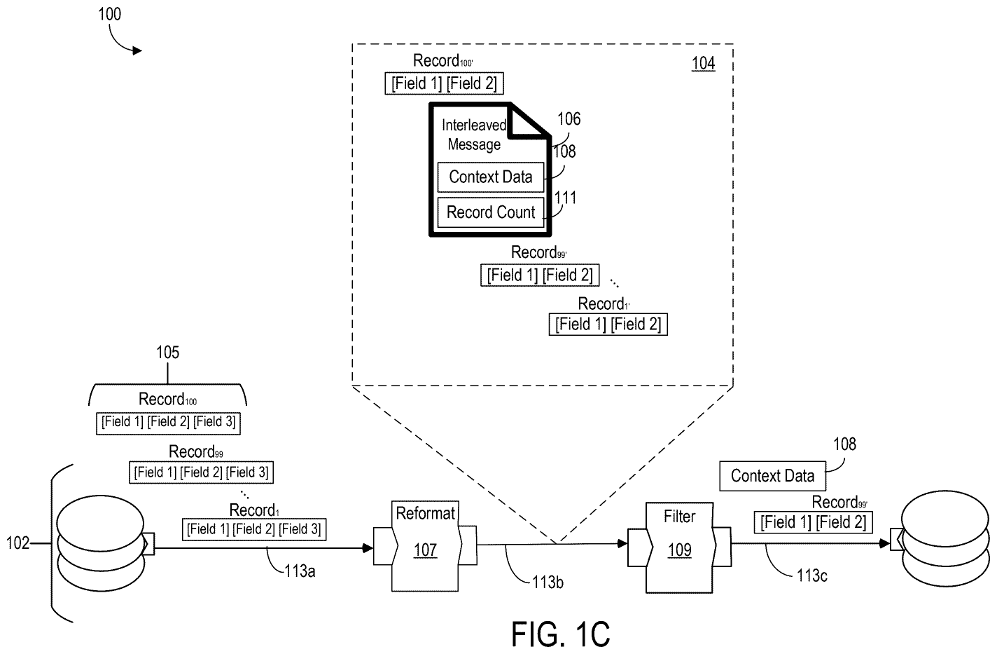

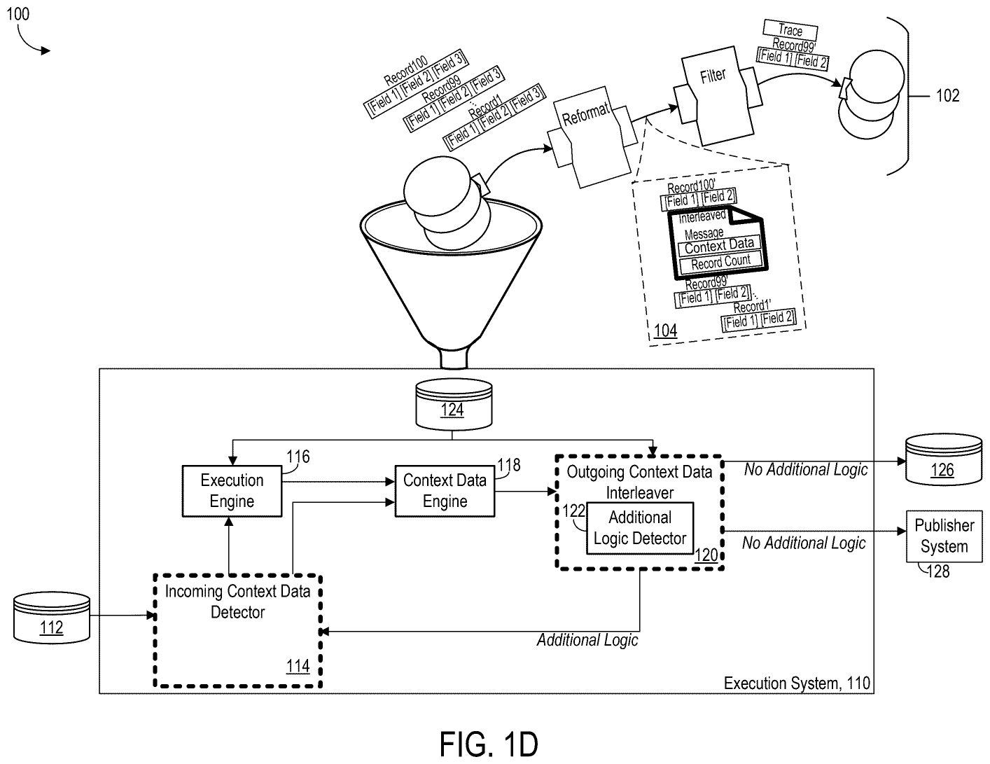

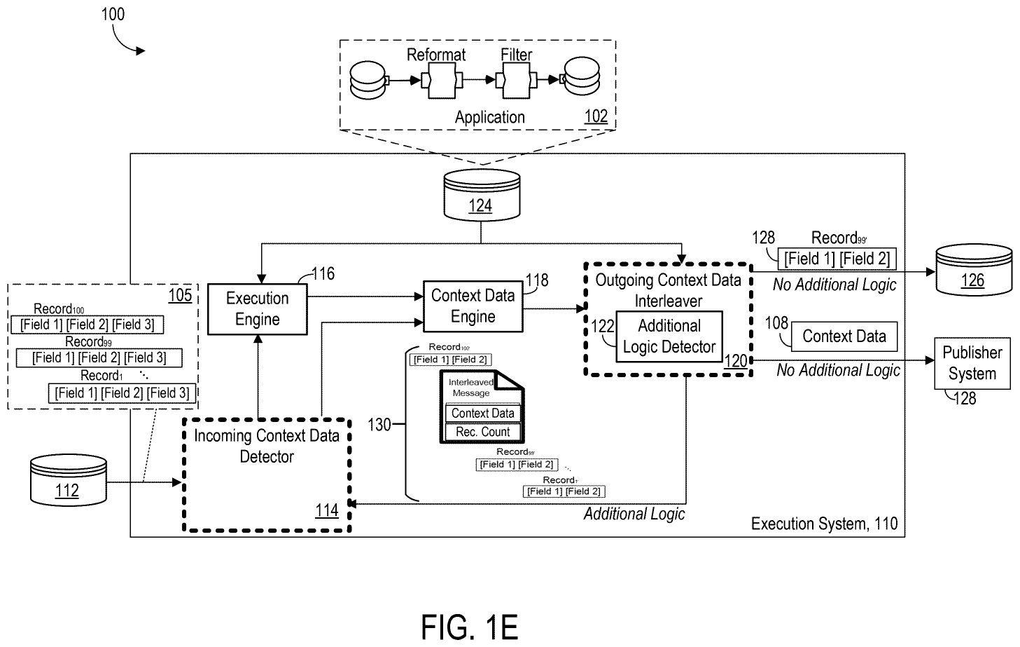

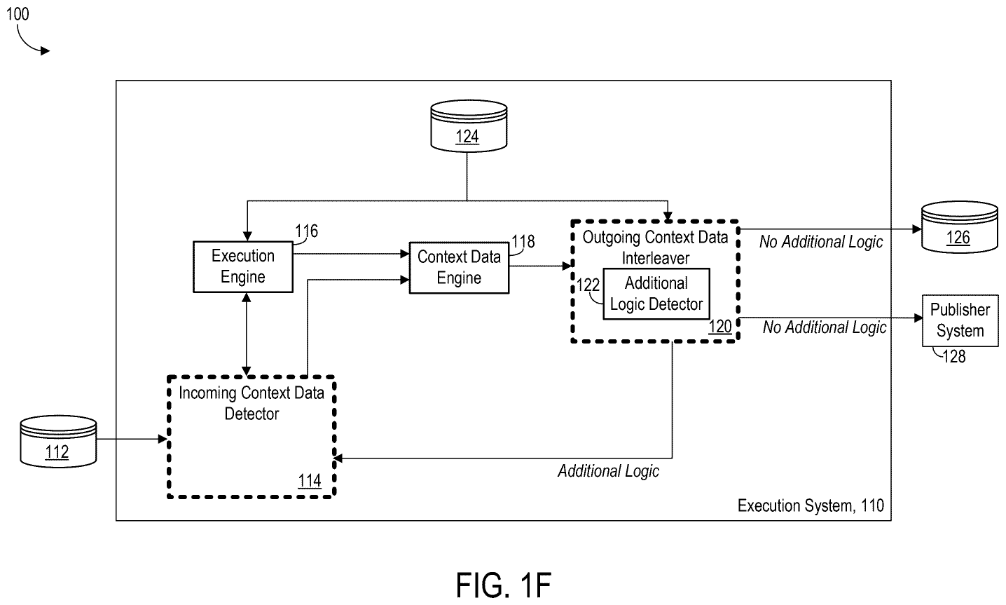

FIGS. 1C-1F are each block diagrams illustrating a data processing system 100 configured for sending contextual data on dataflows of executable dataflow graphs. FIG. 1C shows the data processing system 100 including a data flow graph 102. The data flow graph is configured to send data 104, such as interleaved data 104, between a first component 107 and a second component 109. In this example, the data 104 is interleaved between consecutive data records, but another arrangement is possible for FIG. 1. The (preferably interleaved) data includes a set of data records 105 and an interleaved message 106. The interleaved message 106 includes context data 108 associated with a record count 111 (e.g., record identifier) specifying which record of the records of the set of data records 105 the interleaved message is associated with. The data flows 113a-c of the data flow graph 102 are used for both transmitting the data records 105 and the interleaved message 106. Specifically, data flow 113b is shown as including both the records 105 and the interleaved message 106 that are transmitted together to the second component 109.

The data processing system 100 sends the data records 105 to the first node 107. The first node 107 processes the data records 105, and for one out of every 100 data records, generates context data 108. In an example, the context data 108 includes trace data that specifies how the record was processed. In another example, the context data 108 includes metadata specifying how the record should be processed by the second component 109. As previously described, the components 107, 109 can also be referred to as nodes of the data flow graph 102.

An executable dataflow graph, as employed throughout this disclosure, is a type of computer program that processes data using executable components (which in turn include or represent executable code that carries out data processing functions) included in the dataflow graph. Generally, data from one or more data sources are manipulated and processed by components (also called “nodes”) of a dataflow graph and sent to one or more data sinks. Executable dataflow graphs, such as dataflow graphs, are represented as directed graphs including nodes representing components. The components are data processing components (also called nodes), each component representing or encapsulating executable code for processing data from at least one data input or source and providing data to at least one data sink or output. The components, data sources, and data sink are connected by directed links (also called “edges”), sometimes referred to as data flows, representing flows of data between the components, originating at the data sources and terminating at the data sink(s), each link representing a flow of data. The data output ports of upstream components are connected to the data input ports of downstream components for communicating data across the dataflow links. The data structures and program code used to implement dataflow graphs can support multiple different configurations by being parameterized, e.g., to enable data sources and/or data sinks to be substituted readily. A system for executing dataflow graphs is described in U.S. Pat. No. 5,966,072, titled “EXECUTING COMPUTATIONS EXPRESSED AS GRAPHS,” incorporated herein by reference in its entirety.

In the example shown in FIG. 1C, an interleaved message 106 including context data is generated for one out of every one hundred data records 105. Specifically, an item of context data may not be generated for every single data record of the set of data records 105. For example, when performing distributed tracing, it is not necessary to trace every record of the set of data records 105 to determine how the data flow graph 102 is processing the data records. Rather, a subset of data records of the set of data records 105 can be traced. The subset may be a subset of records that are likely to trigger (e.g., involve for record processing) at least a certain fraction or collection of the nodes of the dataflow graph. A user can specify in an application which records are to be associated with context data by setting a value of a parameter, or automatically selected if expected to be processed by a percentage of nodes exceeding a threshold. The data processing system 100 can then determine which data records of the set of data records 105 should be associated with context data 108.

The data processing system is configured to determine which of the data records each item of context data 108 is associated with based on the record count 111 in the interleaved message 106. When received by a component, such as component 107 or component 109, the interleaved message 106 can be updated (e.g., if used for tracing) or otherwise accessed for processing the record with which it is associated. For example, if the context data 108 of the interleaved message includes parameter values, locations of service calls, or other data that are useful for processing a particular record that the data processing system can access that specifies context data 108 for processing the record with which it is associated.

FIG. 1D shows a data processing system 100 for sending contextual data on dataflows of dataflow graphs. A data source 112 stores the records to be processed by a data flow graph in an execution system 110 (e.g., a runtime environment). The data source 112 can provide the records to the execution system 110 as a set or as a group. The data source 124 stores the application for processing the data records stored in the data source 112. The application includes a data flow graph 102 as described previously. The execution system 110 is configured to execute the logic of the data flow graph by executing the executable instructions of each component in sequence or in parallel as specified by the data flow graph 102.

The execution system 110 includes a runtime environment configured to process the data records using the logic specified by a component. Therefore, the execution system 110 executes for each component. The execution system 110 is configured to perform the logic of a component, determine if there is additional logic such as another component in the data flow graph 102, and if additional logic is present, execute the logic of that component. If no additional logic is present in the data flow graph 102, the execution system 110 is configured to output the processed data records to the data sink 126. Additionally, the execution system is configured to publish the context data at a publisher system 128 if instructed by a client device or if otherwise specified in the data flow graph 102. For example, trace data can be published by a publisher system 128 for the executed data flow graph 102. The trace data are separated from the processed records which are stored in the data sink 126. In an example, the trace data can be published by a third party publisher system 128. Generally, the trace data can be provided to a third party publisher system as binary data and the publisher system can transform the binary data into data for presentation on user interface as desired by the user.

The execution system 110 receives data records from the data source 112 at an incoming context data detector 114. As subsequently described, the incoming context data detector 114 is configured to receive a set of data records and interleaved context data (e.g., in implicit data records). The incoming contact data detector 114 determines which items of context data are associated with which data records of the set of data records received. The incoming context data detector stores these records and context data and buffers, as subsequently described, and sends records and associated context data (if any) in sequence to the execution engine 116.

The execution engine 116 is configured to perform the logical operations specified by a component of the data flow graph 102. In an example, the logic of the component is input into the execution engine 116 depending on a state for processing the data flow graph 102. The state specifies which component is currently actively processing data records. The execution engine 116 is configured to receive a data record from the incoming context data detector 114 and process the data record (hereinafter records) in accordance with the logic specified by the currently active component. If specified by a user, the execution engine 116 is configured to invoke the context data engine 118 to generate, analyze, or update the context data associated with a record that is being processed. The execution engine 116 receives the context data and can use the context data for processing the record if the context data includes data that specifies how that particular record should be processed by the execution engine 116.

The context data engine 118 is configured to generate, update, analyze, or otherwise handle the context data 108 associated with a particular record being processed by the execution engine 116. The context data engine 118 is configured to receive context data for a record being processed by the execution engine, if any. As the execution engine processes the data record, instructions being executed may specify that parameter values are to be read from the context data for processing the data record. The execution engine accesses these values from the context data 108 and processes the data record accordingly. For example, the context data may include values of parameters for processing that individual record. In another example, the context data may include trace data describing how that record has been processed thus far by the data flow graph 102. In this example, the context data engine 118 is configured to receive the trace data and update the trace data representing how the execution engine 116 is processing the data record for this particular component of the data flow graph 102. In another example, the data record has no context data thus far, but the application instructs the context data engine 118 to generate context data for that data record. In this example, the context data generator generates the context data as specified by the logic of the component being executed by the execution engine 116. For example, trace data may be generated that indicates how the particular record is being processed by the execution engine 116. The trace data may specify a time taken to execute the instructions for that record, execute which component processed the record, or specify any other information being traced for that particular record.

The execution engine 116 and the context data engine 118 are configured to send the context data 108 and the processed record to an outgoing context data interleaver 120. The outgoing context data interleaver 120 is configured to interleave the context data items with the processed records for associating individual items of context data with the processed records. The outgoing context data interleaver 120 includes an additional logic detector 122 that is configured to detect whether there is another component downstream in the data flow graph 102, or whether there is no additional logic, and the processed records should be output to the data sink 126 and the context data should be sent to a publisher system 128.

The outgoing context data interleaver 120 is configured to output processed records and items of context data on a same common data flow of the data flow graph 102. The outgoing context data interleaver 120 is configured to determine a count for outputting each processed record. Based on this determined count, the outgoing context data interleaver 120 associates an item of context data with the count of its respective processed record. When each of the processed records are output from the execution system 110, the outgoing context data interleaver 120 checks an output buffer storing items of context data to determine whether an item of context data exists that has a count value associated with the output record. If an item of context data in this output buffer includes a count associated with the outputted record, then that context data item is output on the same data flow as its associated record in proximity to that record. An example, the context data item is output immediately prior to the processed record with which it is associated. In another example, the context data item is output immediately subsequent to the process record with which it is associated. The context data item includes the count of the data record with which it is associated. The data record does not need to include a corresponding count value. Rather, when the processed data record is received by a subsequent component, the component associates that data record with a count value based on how many other data records have been received by that component.

The execution system 1110 is configured to proceed to the next component in the data flow graph 102 if one exists. When the outgoing context data interleaver 120 detects additional logic, the state of the execution system 110 changes to the subsequent component of the data flow graph 102. Additional records are received by the incoming context data detector 114, such as the records processed and output by the outgoing context data interleaver 120. The execution system 110 then processes the records as previously described using the logic of the next component. When there is no additional logic in the data flow graph 102, such as no additional components for processing the data records, the process records are output to a data sink 126 for storage. If desired, the context data can be sent to the publisher system 128 for publishing as requested by a client device. For example, a user interface may display trace data in a format that is easily understood by a user. Generally, the context data can be sent to the publisher system as binary data and the publisher system 128 can transform these binary data into data for viewing in a user interface.

FIG. 1E shows a data processing system 100 including examples of data processed by the execution system 110. As previously stated, a set of records 105 is sent from the data source 112 to the incoming context data detector 114. The incoming context data detector 114 determines whether context data are included within the records 105. The incoming context data detector 114 sends a record to the execution engine 116 for processing in accordance with logic specified by a component of the data flow graph 102, based on the state of the execution system 110 in the data flow graph. The execution engine 116 processes the record as previously described. The context data engine 118 generates context data 108, such as trace data, for being associated with one or more of the records 105. The outgoing context data interleaver 120 interleaves the context data items within the stream of processed records. The interleaved data 130, including the processed records and the context data, are sent to the next component, if one is present in the data flow graph 102. The incoming context data detector 114 receives this interleaved data 130 and performs the process for the next component. As previously described, if no further components are present within the data flow graph 102, the processed records 128 are output to a data sink 126. The output context data 108 are sent to the publisher system 128.

FIG. 1F shows an example of the data processing system 100 including each of the incoming context data detector 114, the execution engine 116, the context data generator 118, the application data store 124, the outgoing context data interleaver 120, the additional logic detector 122, the data sink 126, and the publisher system 128. As previously described, the execution system 110 maintains a state corresponding to the particular component of the data flow graph being processed. The execution system 116 processes each record of the set of received data records based on the logic of the component associated with the current state of the execution system 110.

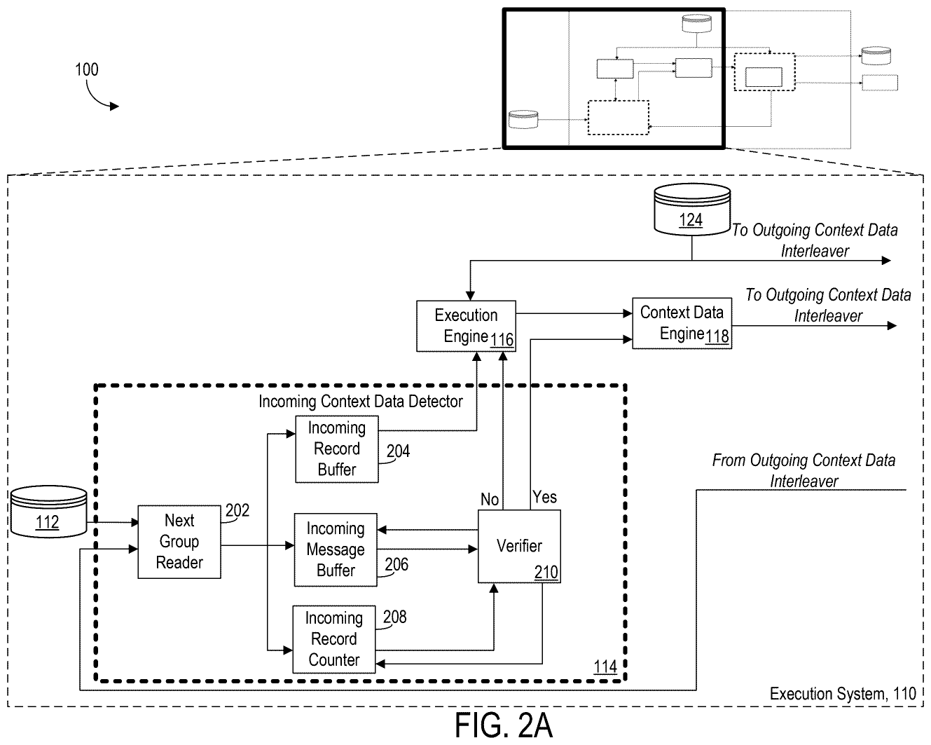

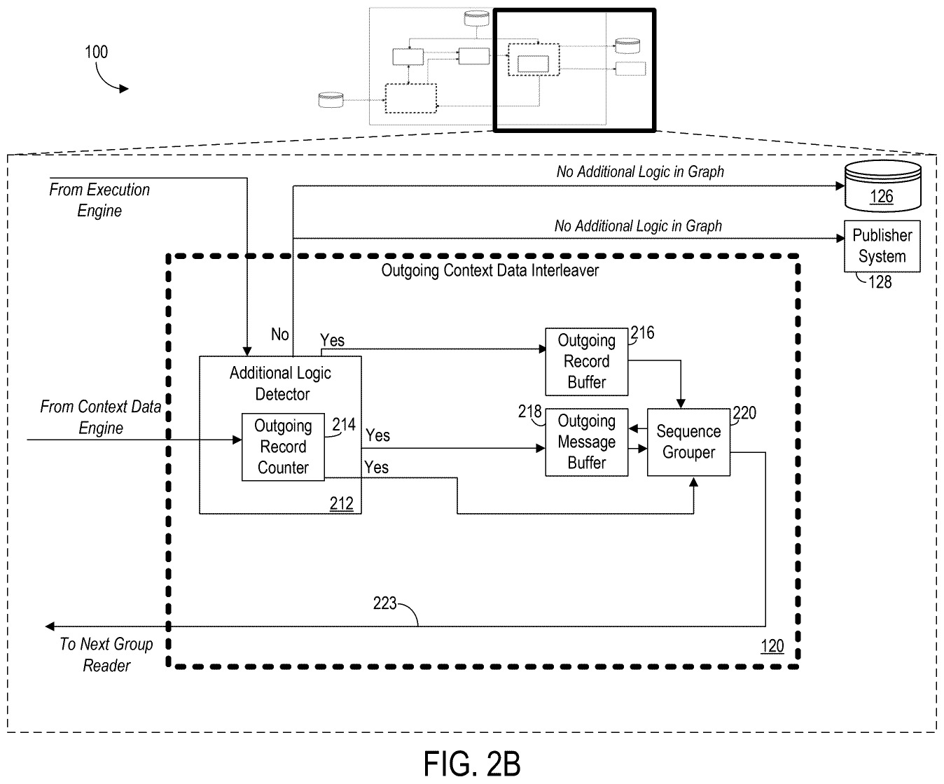

FIGS. 2A and 2B are each block diagrams illustrating the data processing system 100 configured for sending contextual data on dataflows of dataflow graphs. FIG. 2A shows a more detailed display of the incoming context data detector 114 of the execution system 110. The incoming context data detector 114 includes a next group reader 202, an incoming record buffer 204, an incoming message buffer 206, an incoming record counter 208, and a verifier 210. The incoming context data detector 114 is configured to receive a set of data records and determine which of those data records is associated with an item of context data for processing by the execution engine 116 and the context data engine 118.

The next group reader 202 is configured to receive data records from a data source 112. In another example, the next group reader 202 receives processed data records and context data from the outgoing context data interleaver when an upstream component has already processed the data records. The next group reader 202 reads a group of records into an incoming record buffer 204. The next group reader 202 identifies any interleaved messages (e.g., implicit data records) including context data and stores these messages in an incoming message buffer 206. An incoming record counter 208 increments for each received data record.

The execution engine 116 is configured to process each of the records in sequence. When a record is requested by the execution engine 116 for processing, the verifier 210 checks the incoming message buffer 206 to determine whether and interleaved message is stored within the buffer for that particular data record. In an example, the execution engine 116 retrieves data records from the incoming record buffer 204 in a first-in, first-out process. The verifier 210 determines if a count associated with the data record in the incoming record buffer 204 exists in context data stored in the incoming message buffer 206. If context data are found by the verifier 210, the context data are sent to the context data engine 118 for being updated based on processing by the execution engine 116 of the data record. If the verifier 210 does not find any context data associated with the record being processed by the execution engine 116, the verifier instructs the execution engine 116 and the context data engine 118 to proceed without sending any context data. If instructed by the application, such as based on a parameter value received from a client device, the context data engine 118 can generate new context data for the record being processed by the execution engine or skip generating context data for that record. As previously described, the execution engine 116 receives the logic for the current component associated with a state of the execution system 110 from the data store 124 storing the application (e.g., the dataflow graph 102).

FIG. 2B shows a more detailed display of the outgoing context data interleaver 120 of the execution system 110. The outgoing context data interleaver 120 is configured to receive records that have been processed from the execution engine 116 and context data associated with those processed records from the context data engine 118. An additional logic detector 212 receives the processed records from the execution engine 116 and context data from the context data engine 118 to an outgoing record counter 214. The count value of the outgoing record counter 214 is associated with the context data item. The record to the output is stored in an outgoing record buffer 216. The corresponding item of context data to be included in an interleaved message is stored in the outgoing message buffer 218. A corresponding item of context data includes the count from the outgoing record counter 214.

The records are output in the same order as received by the outgoing record counter 214. When a record is to be output by the outgoing context data interleaver 120, the sequence grouper 220 checks the outgoing message buffer 218 to determine whether context data exists for the record about to be output. When context data having the count are stored in the outgoing message buffer 218, the sequence grouper 220 retrieves the context data item and generates an interleaved message for outputting among the data records from the outgoing record buffer 216. The sequence grouper 220 retrieves the next record from the outgoing record buffer 216 and outputs the interleaved message for that record proximate to the data record on the same data flow. In an example, the sequence grouper 220 sends the interleaved message immediately prior to the output processed record. In an example, the sequence grouper 220 sends the interleaved message immediately subsequent to the output process record. The output records and interleaved message are sent on a same data flow to a downstream component for further processing, or output to the data sink 126 or publisher system 128 if there are no subsequent components in the data flow graph 102. In this example, the output data flow includes a logical flow to a subsequent component for processing the data records with additional logic. The data flow is represented by flow 223, but the data flow is actually a logical flow within the data flow graph 102. The flow 223 represents a logical flow to the next component, but because the execution system 110 updates a state and uses the same incoming context data detector 114, the actual logical data flow of the data flow graph 102 is not shown in FIG. 2B.

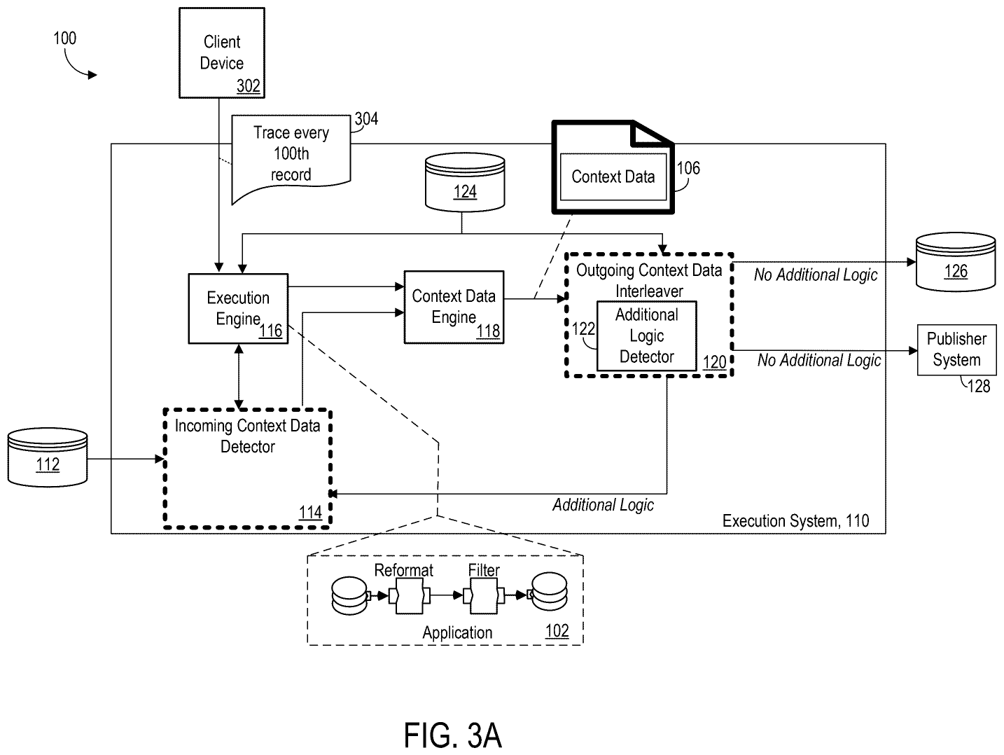

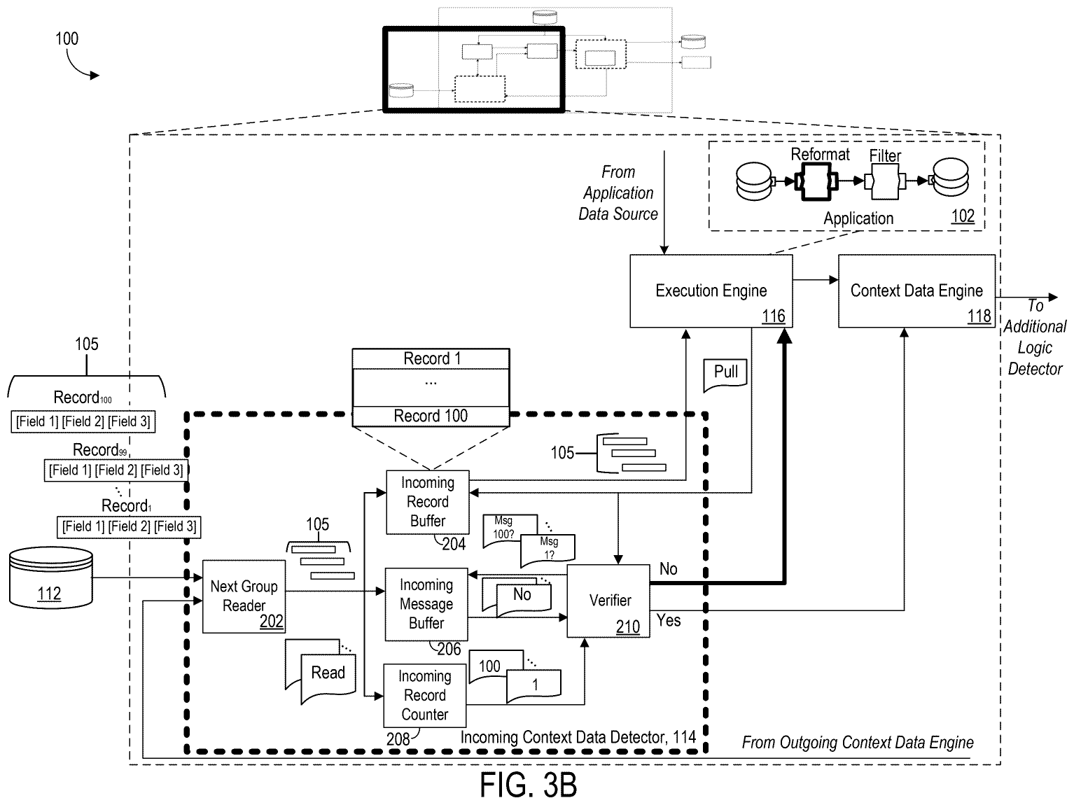

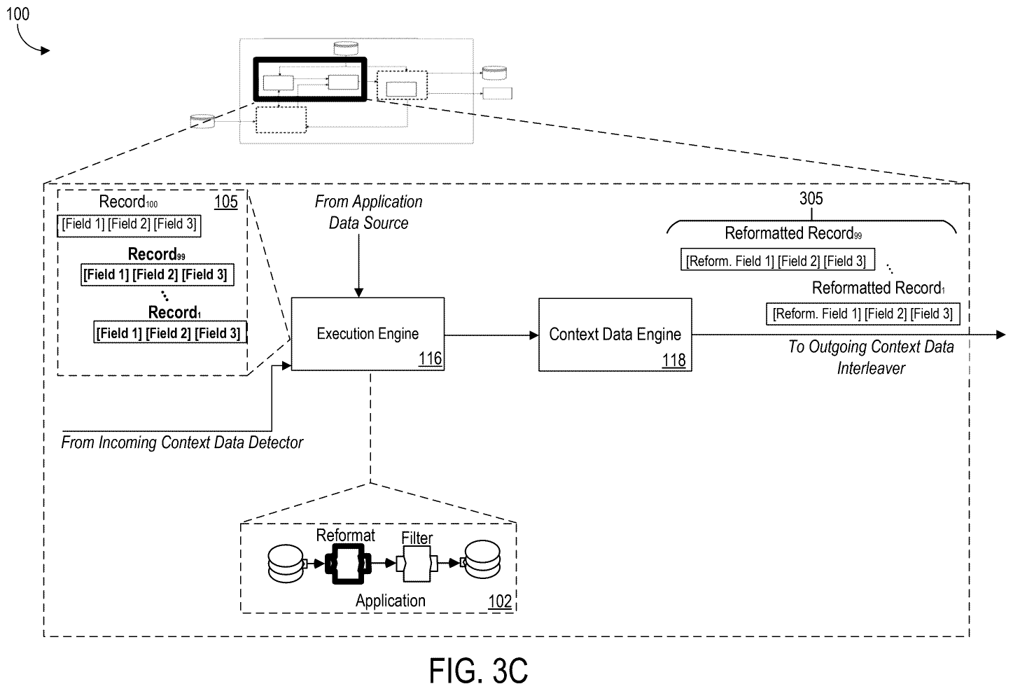

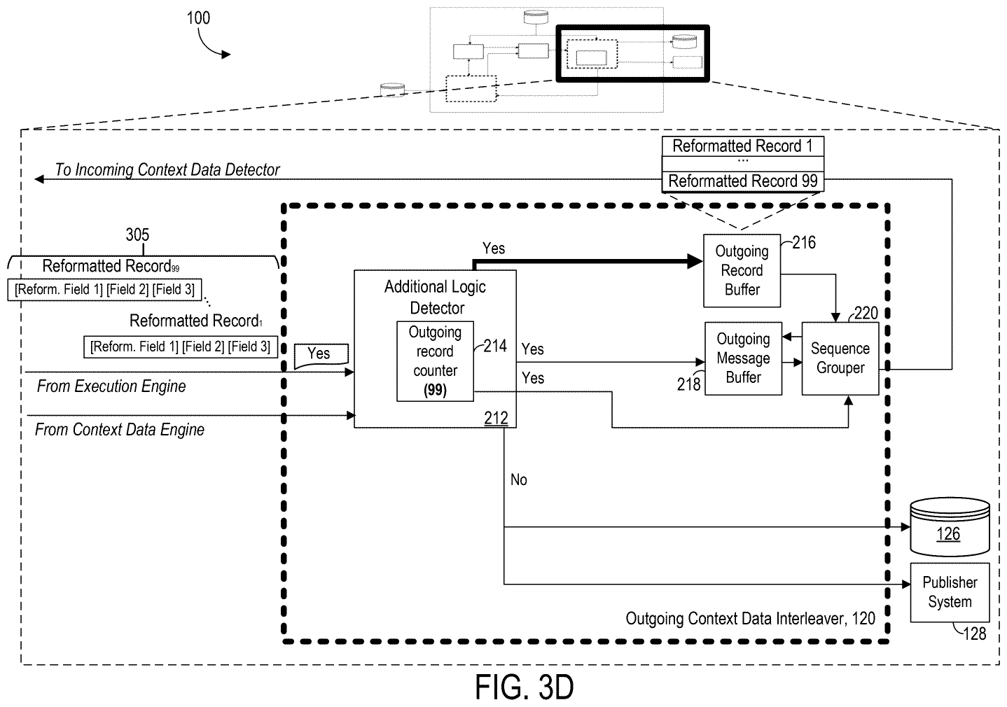

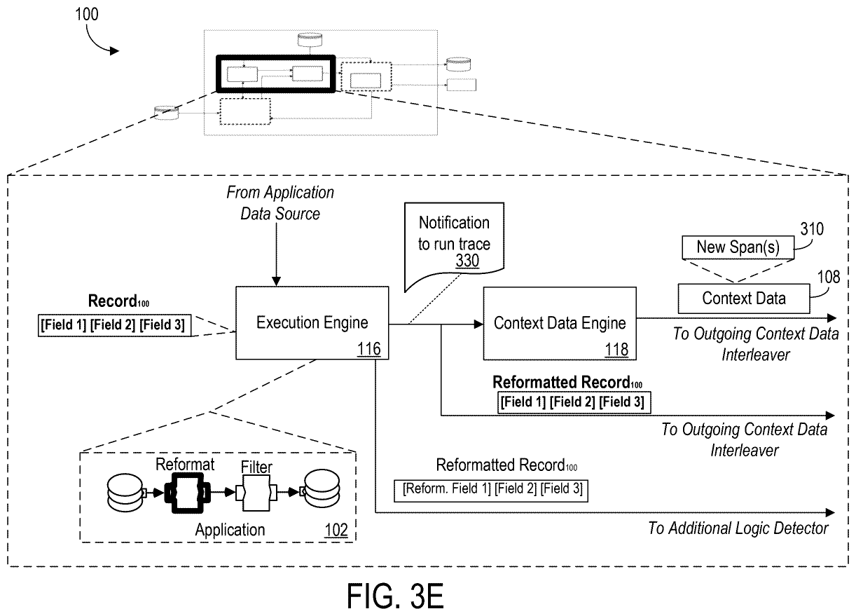

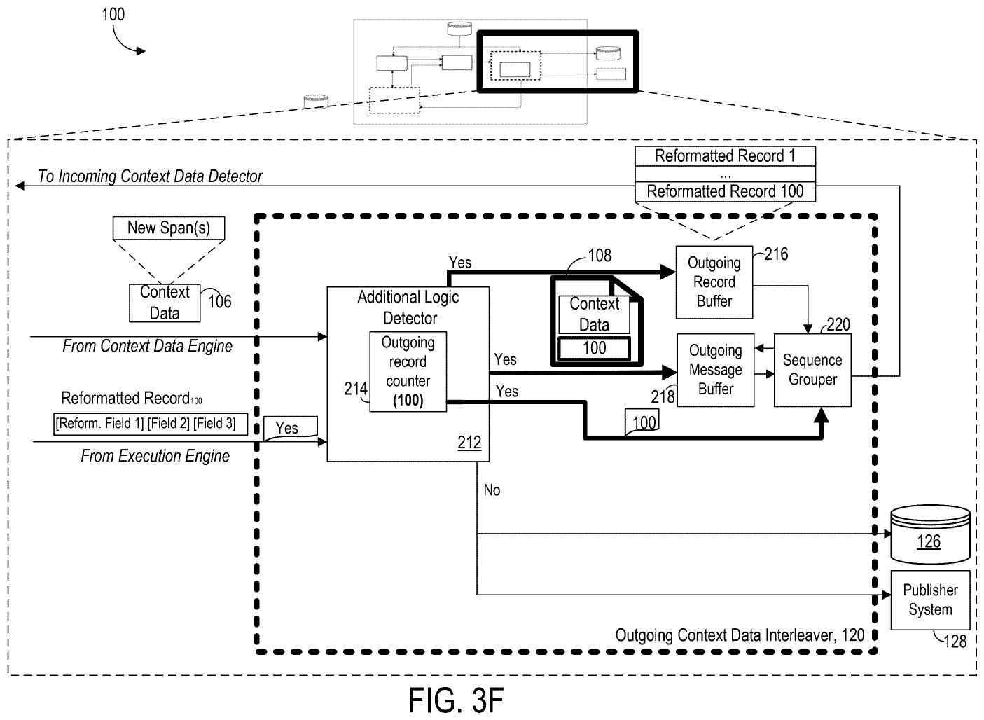

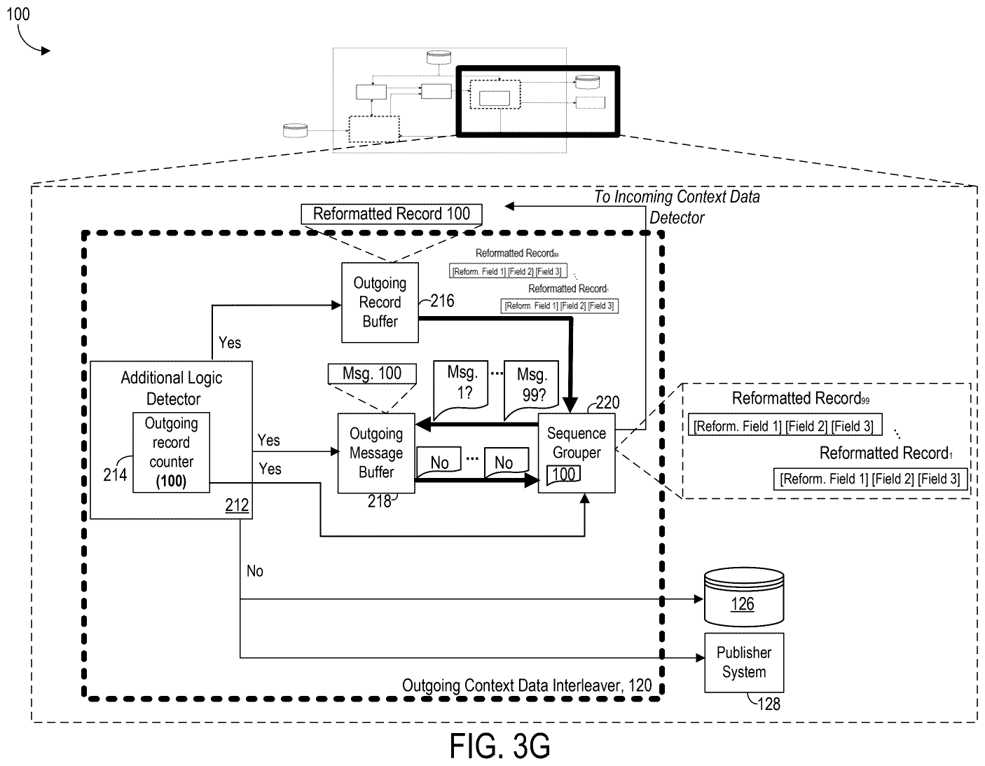

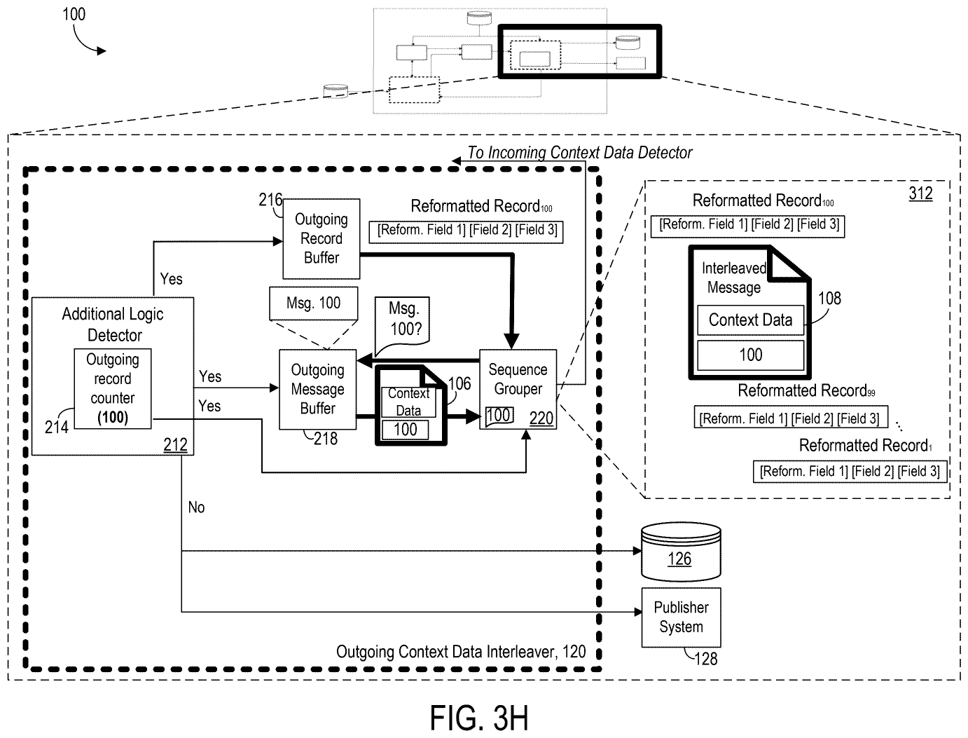

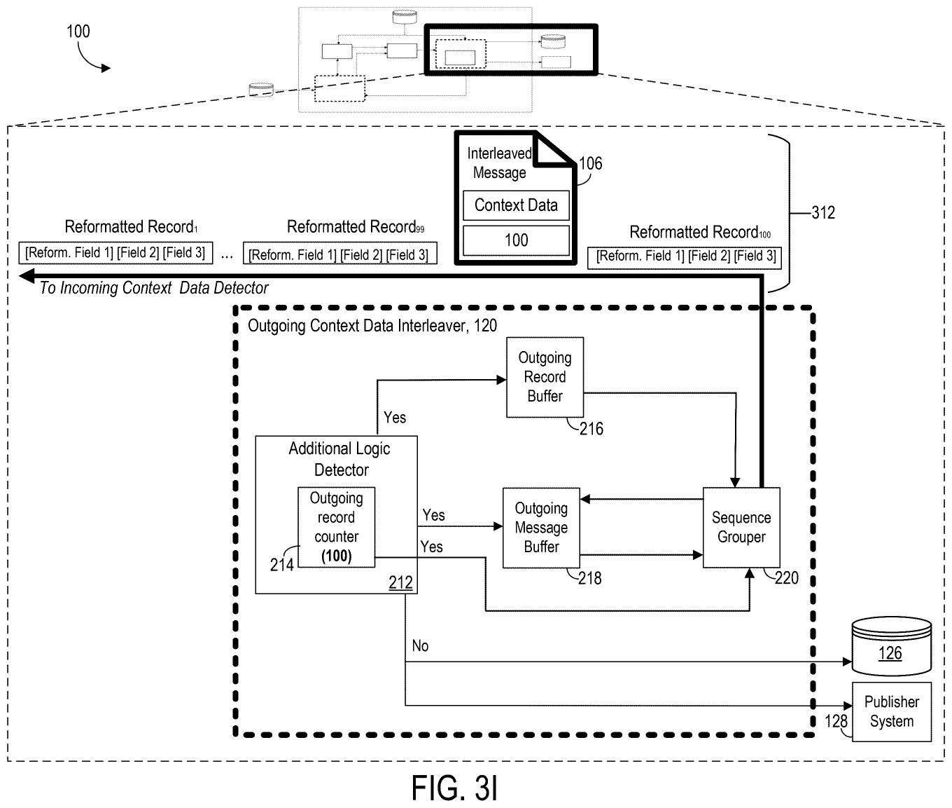

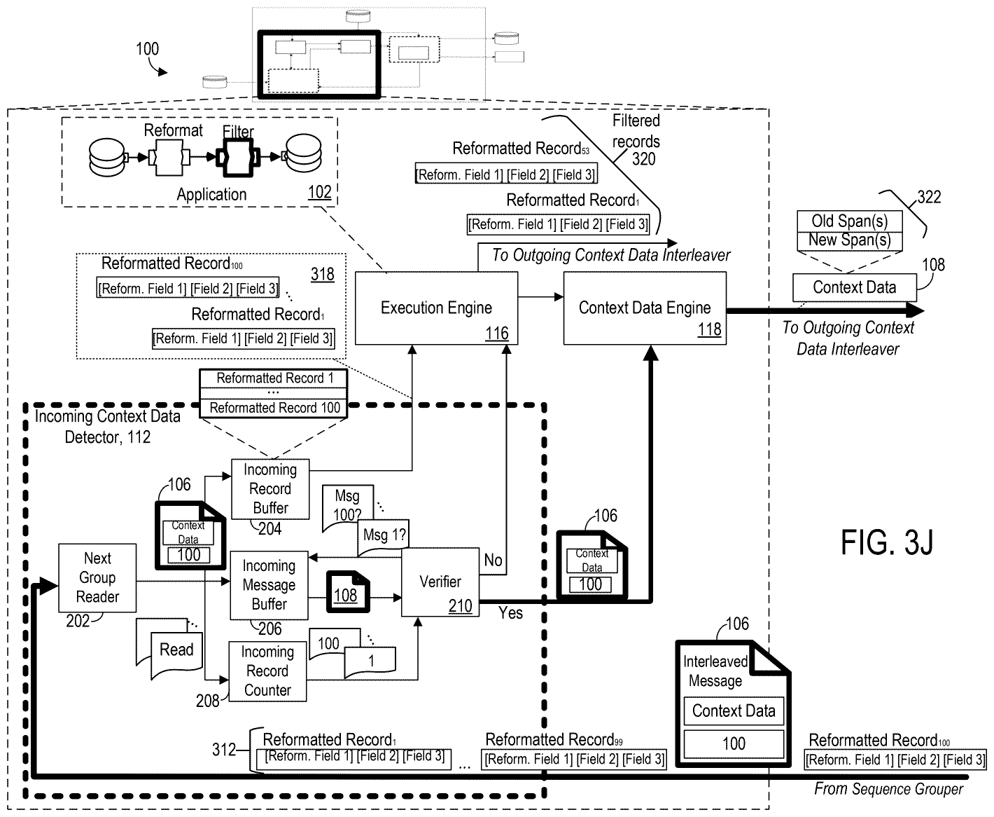

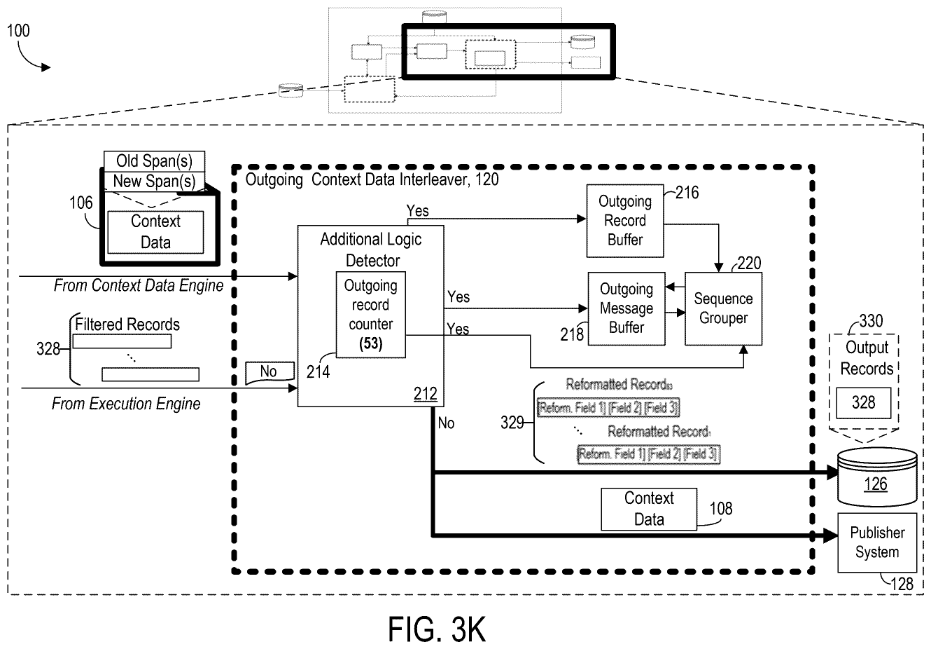

FIGS. 3A to 3K are each block diagrams illustrating the data processing system 100 configured for sending contextual data on dataflows of dataflow graphs. FIG. 3A shows the data processing system 100 receiving an instruction in 304 to trace every 100^{th} data record. However, other examples of context data 108 can be used for the data processing system 100. For example, context data 108 may be associated with each data record when the context data includes values of parameters for processing respective data records. An application includes a data flow graph 102 for processing the data records. The execution system 110 maintains a state corresponding to the particular component being used to process the data records.

FIG. 3B shows the data processing system 100 receiving a set of data records 105 at the incoming context data detector 114. The set of data records 105 includes 100 records. Each of the records includes fields, such as field 1, field 2, field 3, and so forth. The next group reader 202 receives the set of data records 105 and sends them to the incoming record buffer 204. If any interleaved messages are present, the context data are stored in the incoming message buffer 206. In this example, there are no interleaved messages for storing in the incoming message buffer 206.

The incoming record buffer 204 stores the records from record 1 to record 100. These records are sent to the execution engine 116 in sequence for processing by the execution engine. The execution engine processes the records based on state of the execution system 110 determined by the structure of the data flow graph 102. In this example, the data flow graph 102 includes a reformat component and a filter component. The state of the execution system 110 is currently for the reformat component and updates to the filter component once the reformat component processes all of the records 105. The reformat component and the filter component are example components, but any graph component can be substituted for processing the data records in accordance with logic of that graph component. The execution system 110 is configured to process the interleaved messages and data records in a process that is agnostic to any particular logic in the components. Rather, the logic of a particular component affects how the execution engine 116 and context data engine 118 processes the individual records and context data. However, the data records and interleaved messages including context data are received over an input same data flow (or dataflows) of the data flow graph and output over a same output data flow of the data flow graph regardless of the particular logic of the component.

The execution engine pulls a data record 105 and identifies the data record count. The execution engine 116 requests context data from the verifier 210 for that data record. The verifier 210 checks the incoming message buffer 206 to determine whether context data are present for each of the data records 1-100. In this example, there are no context data messages stored in the incoming message buffer 206. For each of the data records, the execution engine 116 receives an answer of “no” from the verifier 210 responsive to the request for any context data. The execution engine 116 therefore processes the records in accordance with the logic specified by the reformat component.

The verifier 210 checks the incoming message buffer 206 based on a count for each record of the incoming record counter 208. For example, the verifier 210 receives a count of one from the incoming record counter 208. The verifier 210 sends a query to the incoming message buffer 206 including the count value of 1. If a message is stored in the incoming message buffer 206 that stores the count value of 1, the verifier verifies that context data are included for the first data record in the incoming record buffer 204. If no messages are stored in the incoming message buffer that include account value of 1, the verifier 210 verifies that no context data are included for the first data record stored in the incoming record buffer 204. The verifier 210 outputs the retrieved context data, if any, to the execution engine 116 and the context data engine 118. If The verifier 210 does not match the count to any context data, the verifier sends a message to the execution engine 116 and to the context data engine 118 indicating that no context data were found.

FIG. 3C shows the data processing system 100 including a run-time environment for processing the records 105 by the data flow graph 102. The execution engine 116 and the context data engine 118 processes each of the data records for the reformat component of the data flow graph 102. Specifically, the execution engine 116 reformats each of the data records as specified by the reformat component logic. As the reformat component reformats the data records, the context data engine 118 can generate context data for each 100th record as specified by the client device. Because there are no existing context data for the data records 105, the context data engine 118 generates new context data for each 100th record, rather than updating the existing context data, such as with additional trace data. The reformatted records 305 are output to the outgoing context data interleaver 120.

The data processing system 100 processes the first 99 records for reformatting the first 99 records. In this example, because every 100th record is associated with trace data, the context data generator does not generate trace data for any of the first 99 records. The execution engine 116 reformats the records to be reformatted records 305. The reformatted records 305 are sent to the outgoing context data interleaver 120.

FIG. 3D shows the outgoing context data interleaver 120 for processing the reformatted records 305. The reformatted records 305 are received by the outgoing context data interleaver 120. The additional logic detector also receives a notification indicating that there are additional components downstream of the present component. The additional logic detector 212 determines whether additional logic is included in the data flow graph 102. In this example, the filter component is downstream of the reformat component in the data flow graph 102. Therefore, the additional logic generator determines that additional logic is present in the data flow graph 102. For the first 99 reformatted records, there are no context data included from the context data engine 118. The additional logic detector 212 increments a count in outgoing record counter 214 for each of the received reformatted records 305. Each of the reformatted records are stored in an outgoing record buffer 216. There are no corresponding context data stored in the outgoing message buffer 218 for these first 99 records. The outgoing record counter 214 increments to a count of 99.

FIG. 3E show the data processing system 100 when the 100th record is processed by the reformat component of the data flow graph 102. In this example, the client system indicated that a trace is to be run for the 100th record describing how the execution engine 116 processed that record for the reformat component. The execution engine 116 and the context data engine 118 processes the 100th record together. When processing the 100^{th} record, the execution engine 116 generates a notification 330 to generate trace data for that record to cause the context data engine 118 to generate context data for that record. When notification 330 is not generated, the context data engine 118 ignores the record and does not generate context data for that record. For trace data, as described herein, context data may be generated every 100^{th} record, which is sufficient for debugging purposes. In some implementations, context data may be generated for every record. The context data engine 118 generates context data representing how the execution engine 116 processed the 100th record. For example, the context data generated can include trace data representing an amount of time that was used to process the 100th record, a state of the execution system 110 (corresponding to the identity of the reformat component) or include any other data that specifies or describes how the execution engine 116 processed the 100th data record.

The context data engine 118 sends the generated context data 108 including the new span or spans 310 generated in that context data for the 100th record. The execution engine 116 sends the 100th reformatted record to the outgoing context data interleaver 120.

FIG. 3F shows a detailed view of the outgoing context data interleaver 120 for outputting the reformatted records when context data are generated for a record. The additional logic detector 212 receives the context data 108 from the context data engine 118. The additional logic detector 212 receives the 100^{th} reformatted record from the execution engine 116. The additional logic detector also receives a notification indicating that there are additional components (e.g., the filter component) downstream of the present component.

The additional logic detector increments a count in an outgoing record counter 214. The context data 108 is associated with the count of the outgoing record counter 214. In this example, the count is equal to 100, as the reformatted record is the 100th record. The context data 108 is associated with the count in a message 106 to be interleaved with the output processed records. The message is stored in the outgoing message buffer 218. The count is also sent to the sequence grouper 220.

The sequence grouper 220 is configured to output the processed data records with the context data message interleaved to be proximate to the processed record with which that message is associated. Therefore, the outgoing message buffer 218 stores the context data message 108 that has a count of 100. The outgoing record buffer 216 stores the 100 processed records.

FIG. 3G shows a detailed view of the outgoing context data interleaver 120 for outputting the reformatted records when no context data are generated for records. The sequence grouper 220 retrieves, for each record to be output, an indication from the outgoing message buffer 218 indicating whether a context data message is stored in the buffer for the record being output. In this example, the first 99 processed records do not have corresponding context data messages stored in the outgoing message buffer 218. The sequence grouper 220 requests for each of these records whether a message is present in the outgoing message buffer 218, and for each message receives an answer of “no”. The sequence grouper then outputs each of the first 99 records on the output data flow in a sequence without any interleaved messages.

FIG. 3H shows a detailed view of the outgoing context data interleaver 120 for outputting the reformatted records when context data are generated for a record. The sequence grouper 220 is now ready to output the 100th processed record. For the 100th processed record, context data has been generated and is stored as a message in the outgoing message buffer 218. The context data message is associated with a count of 100, as previously described. The sequence grouper 220 sends a request to the outgoing message buffer 218 asking whether a message is included in the buffer associated with a count of 100. Because a message including a count of 100 is stored in the buffer 218, the outgoing message buffer returns the message 106 to the sequence grouper 220. The sequence grouper then outputs the message 106 interleaved with the output records in a position proximate to the 100th record. In this example, the context data message 108 is output immediately prior to the 100^{th} reformatted record. However, in other examples, the interleaved message 106 can be output immediately subsequent to the 100th reformatted record. The sequence grouper 220 therefore generates an interleaved stream 312 of process records and interleaved messages on a same data flow. The interleaved stream 312 is sent either downstream to a subsequent component as previously described or stored/published if no additional logic exists. in this example, a downstream component, specifically a filter component, is detected, as described previously. The data stream 312 is output to the subsequent component for further processing.

FIG. 3I shows a detailed view outputting the reformatted records when context data are generated for a record. The stream 312 is output on a common component to the next group reader of the incoming context data detector 114. As shown in the stream 312, the interleaved message 106 is sent between the 99^{th} reformatted record and the 100^{th} reformatted record in the stream. The message 106 is therefore proximate to the 100^{th} record that it describes.

FIG. 3J shows a detailed view of the incoming context data detector 114 when data records are received that include context data. The stream 312 of processed records and interleaved messages 106 are received at the next group reader 202. The next group reader 202 receives the 100 records and stores the 100 records in the incoming record buffer 204. The next group reader 202 determines if any context data are included in the stream 312. For any interleaved messages 106 in the stream 312, the next group reader 202 stores the messages in the incoming message buffer 206. For each record, an incoming record counter 208 is incremented. The verifier 210 checks, for each record, whether context data 108 are present in the incoming message buffer 206 as the execution engine 116 processes all of the reformatted records 318. As previously described, for the first 99 records, no context data messages are retrieved from the incoming message buffer 206 by the verifier 210. For these 99 records, the execution engine 116 and context data engine 118 process the record as described previously, except in this example, the records are filtered rather than reformatted.

When the execution engine 116 is processing the 100th record, the verifier checks the incoming message buffer 206 and finds that context data 108 are present in the buffer for the record. As previously described, the verifier 210 checks the incoming message buffer by checking for each count from the incoming record counter 208. In this example, the verifier 210 sends a count of 100 to the incoming message buffer 206. Because the message 106 has a count of 100, that message is sent to the verifier 210 in response to the query including the count of 100. The verifier 210 sends the context data 108 to the context data engine 118 for being updated as the execution engine 116 processes the 100th record. In this example, new spans can be generated to supplement the old spans of the trace data. The new spans and the old spans together form a trace 322. The trace 322 specifies, for example, how long each of the components of the data flow graph 102 took to process the 100th record. In another example, the message 106 may include instructions or parameter values associated with processing the 100 data records by the execution engine 116. The execution engine 116 sends the processed records, including the filtered records 320, to the next component detector of the outgoing context data interleaver 120. In this example, 53 records remain of the initial 100 records in the filtered records 320. The corresponding context data 108 for the 100th record is then associated with the same record of the filtered records. In this example, the context data 108 may be associated with the 53rd record.

FIG. 3K shows a detailed example of the outgoing context data interleaver 120 for outputting data records when no further components are included in the data flow graph 102. In this example, the filtered records 328 and the context data 108 are received by the additional logic detector 212. An indicator specifying that no additional logic exists is also received by the additional logic detector 212. The additional logic detector increments the count of the outgoing record counter 214. In this example, because there are no additional components in the data flow graph 102, the filtered records 328 are sent to the data sink 126 for storage for subsequent processing of other applications. The associated context data 108 are sent to a publisher system 128 for publishing on a user interface or storing for subsequent processing or other applications.

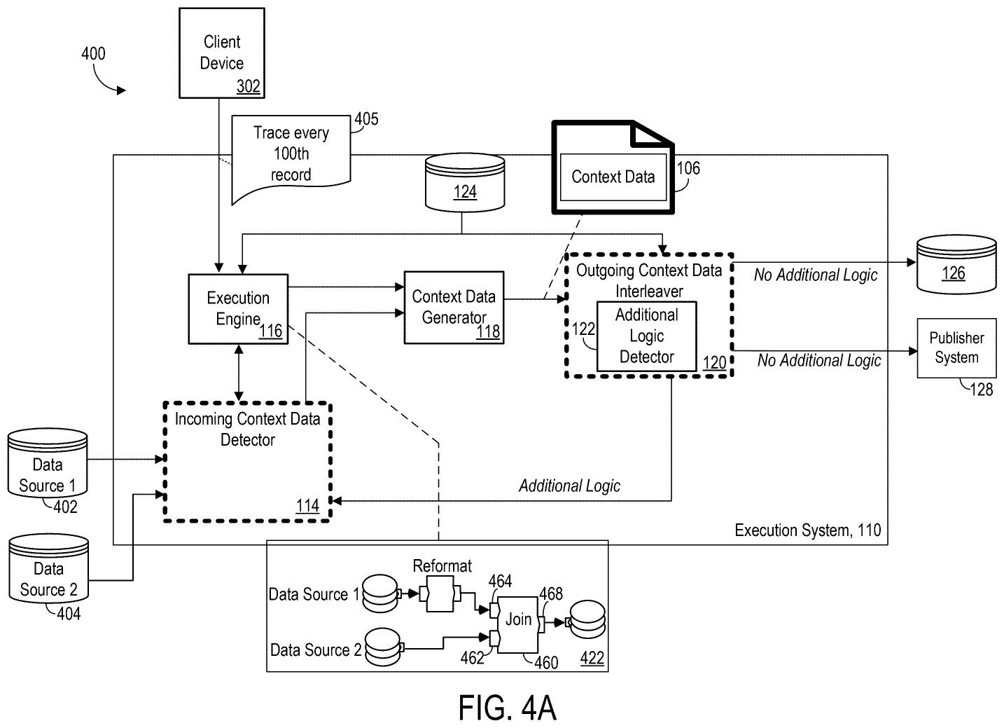

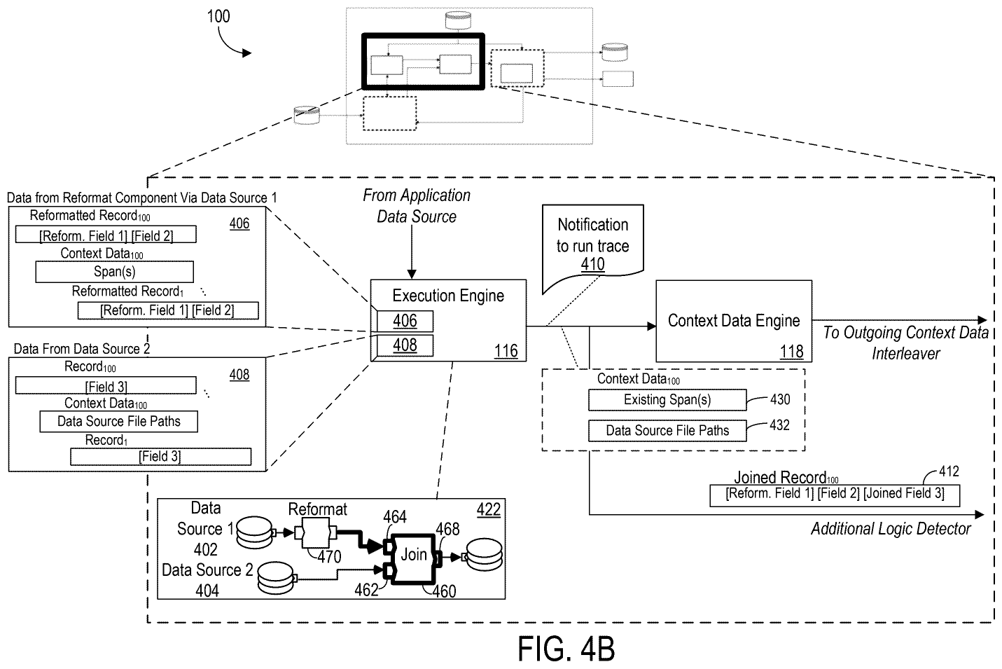

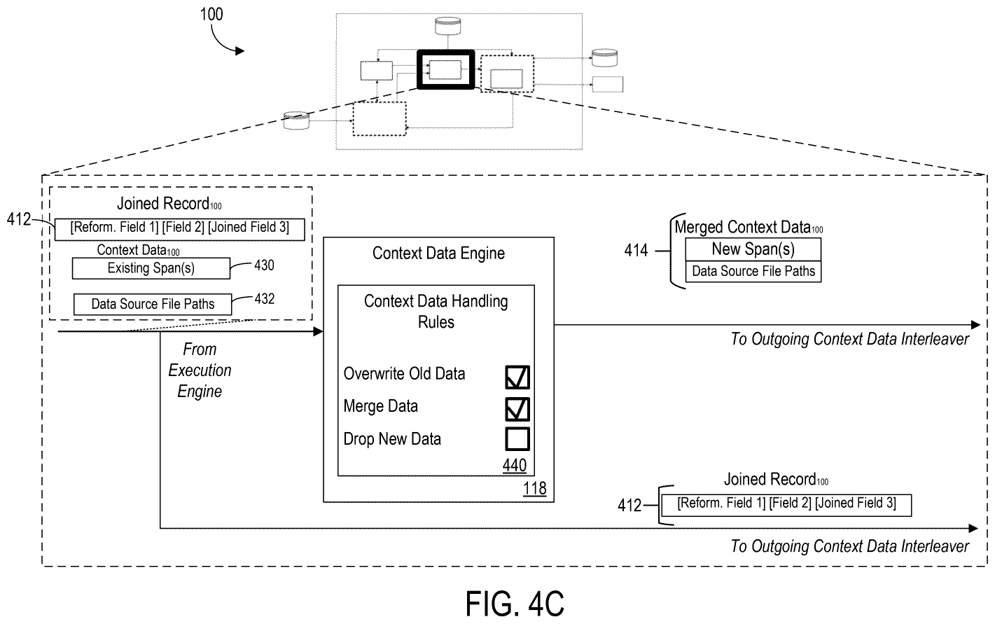

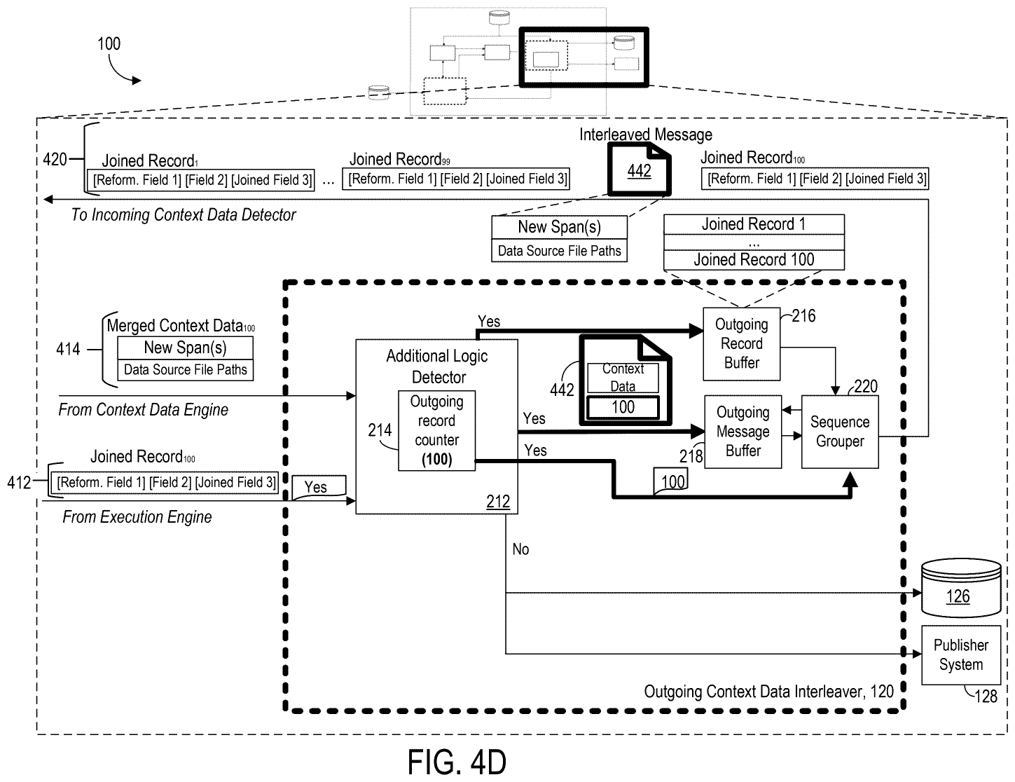

FIGS. 4A-4D are block diagrams illustrating a data processing system 400 for performing tracing. Data processing system is configured to perform tracing using a context data as described previously.

FIG. 4A shows a data processing system 400 similar to the data processing system 100, described previously. The data processing system 400 is configured to receive context data, such as trace data or other data describing execution of one or more components of the application 422, from multiple sources 402, 404. In some implementations, a component 460 of the application 422 can include multiple inputs 462, 464. In some implementations, the component 460 can include a join component that combines two records into a single record. In this scenario, the execution engine 116 and context data engine 118 are instructed to generate a trace for every 100^{th} record, as shown by instruction 405 similar to the instruction 304 of FIG. 3A. The context data engine 118 can process incoming context data from two separate records and output context data for the joined record.

Depending on the particular application 422 or component 460 functionality, there can be different rules for handling the incoming context data from multiple data sources 402, 404 or upstream components. This is because the component 460 can receive context data on each input 462, 464 but outputs only one set of context data on output 468. The component 460 is configured to determine how to handle multiple instances of context data from upstream components or data sources based on rules associated with the component. For example, when the context data includes trace data, the component 460 cannot always preserve both traces, one associated with each incoming record. Instead, the component 460 can be associated with instructions to prioritize one set of context data over another set and drop the other set, merge spans from both traces (if possible), generate entirely new context data, overwrite existing context data, or perform some other action. In other examples, the old context data from each source can simply be combined with any new context data, and the combined context data can be associated with the output record.

FIG. 4B shows an example of an execution engine 116 that is executing the logic of the join component 460. In this scenario, the join component 460 has already received data 406 from the upstream reformat component 470 and data 408 from the data source 404 (e.g., data source 2). The join component 460 includes executable instructions to join fields of records from data 406 and 408 and output a joined record 412. Each input record can include context data (such as ContextData₁₀₀ of data 406). In an example, the context data of each set of data 406, 408 can specify trace data of how the record has been processed so far by the application 422, data supporting execution the logic in the join component, or any other such data that is not part of the record being processed. In this embodiment, the execution engine 116 generates a notification 410 to run a trace for the 100^{th} record, as described previously in relation to FIG. 3B. While context data are only being generated for each 100^{th} record in this example, it is possible that context data are generated for each record.

The joined record 412 and any existing (upstream) context data 430 are sent to the context data engine 118. In this example, the joined record 412 includes context data generated during generation of the reformatted record 406. The generated context data of input record 406 include spans from data processing tracing. The tracing of the context data for record 406 describes how the record 406 was processed by the reformat component. For example, the spans of the context data for record 406 can specify how long the reformat component took to reformat an input to generate record 406, which portion of the application processed the record 406 with the reformat logic, or other such description information that can be typically included in trace data. The source record 408 has not yet been processed. However, context data 432 associated with the source record 408 specifies additional information that is useful for at least part of the application 422 when processing the record. In this example, the context data 432 associated with record 408 specifies file paths for additional data sources that may be used as part of a service during execution of the application. However, the context data 432 can include any other data associated with a record that is relevant to processing of the record by the application 422 but not included in the record, as described previously.

The context data engine 118 is configured to generate context data for the processed joined record 412. In some implementations, the context data engine 118 receives only the context data to be updated. In some implementations, the context data engine 118 receives the joined record 112 in addition to the context data. Generally, the execution engine 116 and context data engine 118 are part of the same runtime environment and are processing the records together to generate the joined data and context data, rather than being upstream/downstream of one another.

FIG. 4C shows an example of the data processing system 100 in which the context data engine 118 generates context data for the joined record 412 when there is at least some existing context data 430, 432. The context data engine 118 is configured to handle the context data depending on how the application 422 is configured or what kind of information is included in the context data 430, 432. For example, when the context data includes trace data (such as context data 430), it may not be practical to preserve spans from two individual records that are joined. Rather, the application, to perform distributed tracing, may be configured to drop one set of spans and preserve the other set of spans. The span that is preserved can be the older (longer) span, the span from a particular upstream source, component, or application, spans associated with a particular flag, or any other such priority rule configured for the application. For example, if a user is debugging a particular portion of the application 422, the user may specify that data traces from a particular processing workflow are to be a highest priority, followed by those from one or more other workflows (sets of components that processed a data record). In another example, if the context data includes data supporting processing of the data records, the application 422 can be configured to preserve these data no matter what. In this example, if the context data includes metadata specifying a data source for reference data used during processing, an address of a service call, or any other such data, the application 422 can be configured to ensure that these context data are always preserved for downstream components. The data processing system 100 can therefore ensure that these data are maintained and available for supporting data processing without requiring the user to embed these data in records to be processed (e.g., user data). The metadata handling can therefore be hidden from the user's perspective, instead of being handled at the application layer, separate from the data records.

The context data engine 118 includes a logic engine 440 that processes the received context data 430, 432 according to one or more configuration rules. The rules can specify whether the context data 430, 432 are to be preserved, dropped, combined, updated, or processed in some other way, as previously described. In this example, the logic 440 is configured to overwrite old spans of the trace data 430 and preserve/combine the data source file paths of context data 432 by merging these data into the trace data generated for the joined record 412. The output result is merged context data 414 including new spans describing the joined record 412 and the data from the context data 432 merged into the context data 414. The context data 414 and the joined data record 412 are each passed to the outgoing context data interleaver 120 for interleaving the context data 414 into the output data records as described in relation to FIGS. 3A-3K.

FIG. 4D shows the outgoing context data interleaver 120 configured to interleave the context data 414 into the processed joined data records 420. The additional logic detector 212 assigns a count value by counter 214 to the joined record 412 and the context data 414 associated with the joined record 412. A notification indicates that there is additional logic in the application 422 for processing the joined record 412. The context data message 442, now associated with a count value of “100”, is stored in the outgoing context data message buffer 218. The joined data record 412 is stored in the outgoing record buffer 216 with other records to be output. The outgoing context data interleaver 120 outputs the context data message 442 in proximity to the record 412, in this case, immediately before the record 412. As described previously, components of the application can associate the processed records with the appropriate corresponding context data message 442 based on the location of the context data message in the stream of output records. The count value (100) in the context data message 442 can be used to associate the context data message 422 with the 100^{th} joined record when the 100^{th} joined record is being processed by a downstream component at a later time.

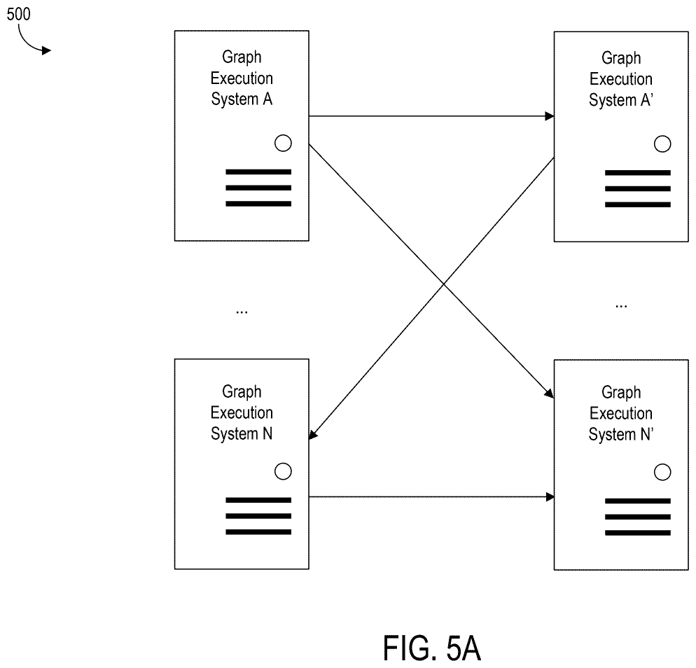

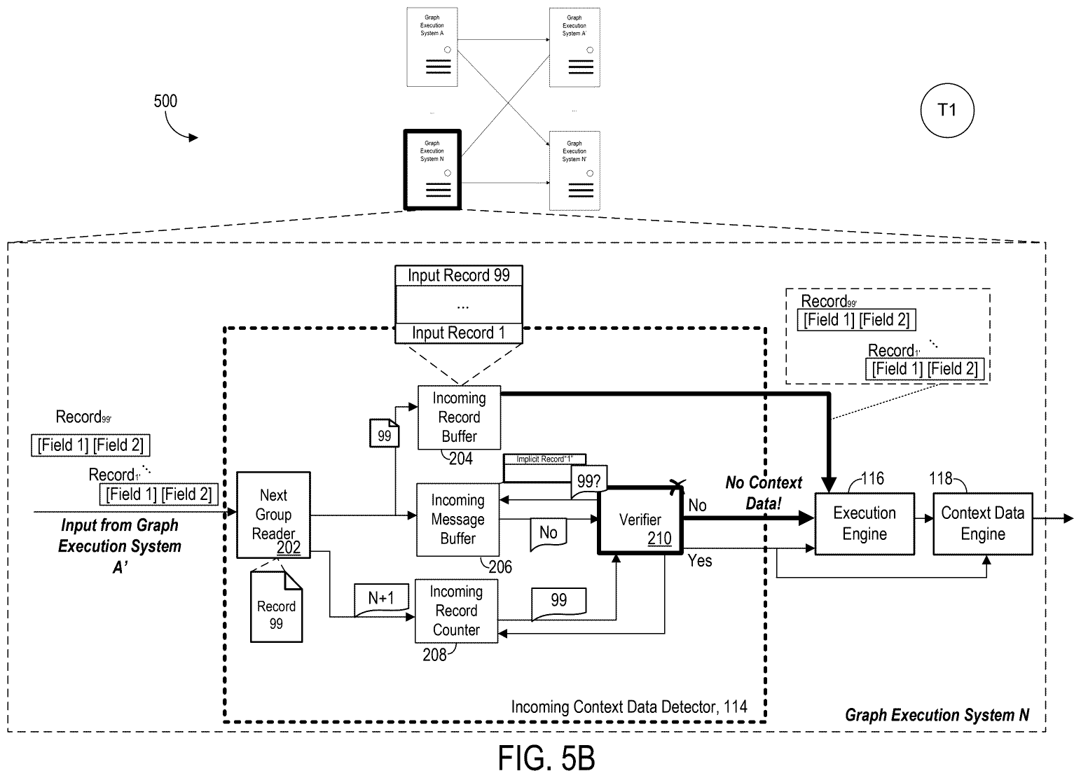

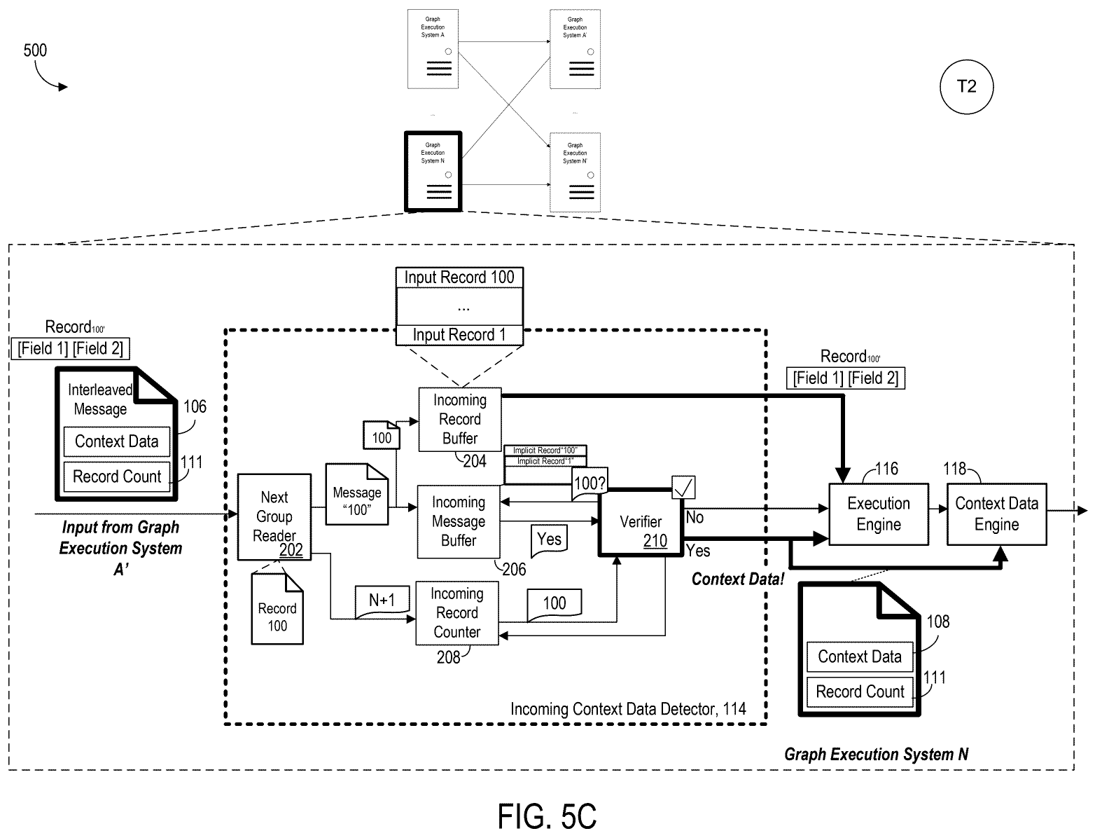

FIGS. 5A-C are block diagrams illustrating an example system 500. In the example of system 500, a plurality of actual processing devices A, A′, N, and N′ are used to process the records by executing the logic of the components of the data flow graph 102.

FIG. 5A shows the networked system of graph execution systems A to N′. As previously discussed, it can be difficult to determine which of these systems will actually process a particular record of the set of data records described previously. To facilitate tracing of data records, the context data including a trace is sent proximate to the data record for processing by components by any of the graph execution systems. In this way, none of the graphic execution systems need to be modified specifically to handle trace data for particular records. Specifically, each instance of the graph running on the respective graph execution systems A to N′ can execute without modification for tracing the data records. Additionally, a data record does not need to be modified to include additional fields or modified in another way to include the trace data describing how that record was processed. This facilitates processing of the data records by the graphs because parameters for tracing the data records can be changed for one of the graph execution systems without requiring other graph execution systems to be modified. Therefore, if a particular graph execution system is executing poorly, additional attention can be paid to that graphic execution system, such as running traces on additional records, without changing how the other graphics execution systems execute.

FIG. 5B shows an example of a data processing system including graph execution system N configured to process the data records as previously described. In this example, the incoming context data detector 114 is configured to receive records from a different system, including graph execution system A′. The incoming context data detector 114 does not have any other information from the graph execution system A′ other than a state of the data flow graph 102 being executed by the graph execution system A′. The graph execution system N is configured to identify from the received data records an item of context data interleaved within the records. As previously described, the verifier 210, record buffer 204, message buffer 206, and record counter 208 are together configured to determine whether context data exists for given records or not. In this example, the first 99 records do not have any context data. this information is sent to the execution engine 116 and context data engine 118 for processing the first 99 records.

FIG. 5C shows an example of a data processing system including graph execution system N configured to process the data records as previously described. In this example, the incoming context data detector 114 is configured to receive records from a different system, including graph execution system A′. The incoming context data detector 114 does not have any other information from the graph execution system A′ other than a state of the data flow graph 102 being executed by the graph execution system A′. The graph execution system N is configured to identify from the received data records an item of context data interleaved within the records. As previously described, the verifier 210, record buffer 204, message buffer 206, and record counter 208 are together configured to determine whether context data exists for given records or not. In this example, for the 100th record, the verifier 210 determines that context data 108 is present for the 100th record. The verifier 210 sends the context data 108 to the context data engine 118 for being modified and to the execution engine 116 (if needed) for assisting the processing of the 100th record.

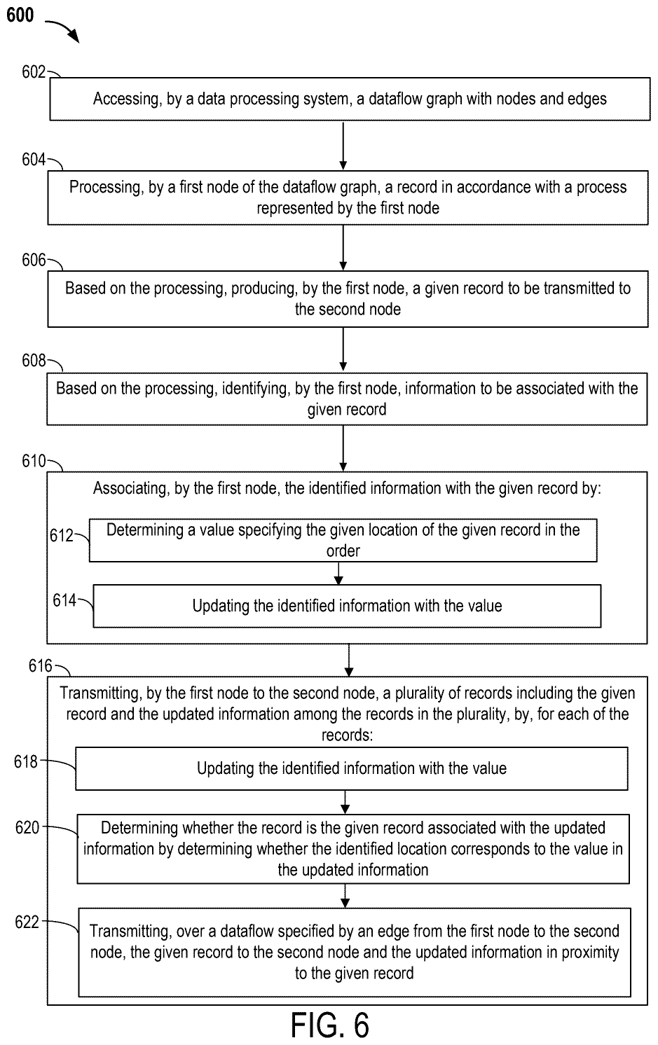

FIG. 6 illustrates an example process 600. The process 600 can be performed by the data processing system 100 described herein. The process 600 is implemented by the data processing system 100 for processing records with a dataflow graph by transmitting the records over a dataflow of the dataflow graph and by transmitting, among the records, information, associated with the processing of the records, over the same dataflow without modifying the records. The process 600 includes accessing (602), by a data processing system, a dataflow graph with nodes and edges, with a node representing one or more processes and with an edge representing dataflow between nodes, wherein a first node of the nodes is configured to transmit data to a second node of the nodes. The process 600 includes processing (604), by a first node of the dataflow graph, a record in accordance with a process represented by the first node. The process 600 includes, based on the processing, producing (606), by the first node, a given record to be transmitted to the second node, wherein the first node is configured to transmit records in an order to the second node, with the given record being at a given location in the order. The process 600 includes, based on the processing, identifying (610), by the first node, information to be associated with the given record. The process 600 includes associating (612), by the first node, the identified information with the given record by: determining (612) a value specifying the given location of the given record in the order; and updating (614) the identified information with the value. The process 600 includes transmitting (616), by the first node to the second node, a plurality of records including the given record and the updated information among the records in the plurality, by, for each of the records: identifying (618) a location of the record among the records in the plurality; determining (620) whether the record is the given record associated with the updated information by determining whether the identified location corresponds to the value in the updated information; and when the identified location corresponds to the value in the updated information, transmitting (622), over a dataflow specified by an edge from the first node to the second node, the given record to the second node and transmitting, over the same dataflow to the second node, the updated information in proximity to the given record.

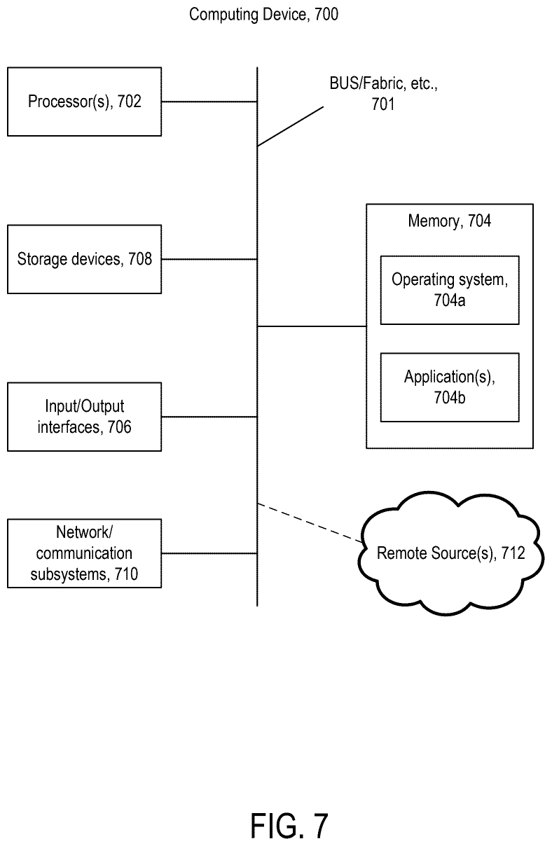

Referring to FIG. 7, an example operating environment for implementing embodiments of the present invention is shown and designated generally as computing device 400. Essential elements of a computing device 700 or a computer or data processing system or client or server are one or more programmable processors 702 for performing actions in accordance with instructions and one or more memory devices 704 for storing instructions and data. Generally, a computer will also include, or be operatively coupled, (via bus 701, fabric, network, etc.) to I/O components 706, e.g., display devices, network/communication subsystems, etc. (not shown) and one or more mass storage devices 708 for storing data and instructions, etc., and a network communication subsystem 710, which are powered by a power supply (not shown). In memory 704, are an operating system 704a and applications 704b for application programming.

Devices suitable for storing computer program instructions and data include all forms of non-volatile memory, media and memory devices including by way of example, semiconductor memory devices (e.g., EPROM, EEPROM, and flash memory devices), magnetic disks (e.g., internal hard disks or removable disks), magneto optical disks, and CD ROM and DVD-ROM disks. The processor and the memory can be supplemented by, or incorporated in, special purpose logic circuitry.

To provide for interaction with a user, embodiments of the subject matter described in this specification are implemented on a computer having a display device (monitor) for displaying information to the user, and a keyboard and a pointing device, (e.g., a mouse or a trackball) by which the user can provide input to the computer. In addition, a computer can interact with a user by sending documents to and receiving documents from a device that is used by the user (for example, by sending web pages to a web browser on a user's device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

Embodiments of the subject matter described in this specification can be provided from a cloud or other remote source(s) 712, as a download or as a service. For example, the embodiments of the subject matter can be provided on-demand in response to a request from a client device.

The software may be provided on a tangible, non-transitory medium, such as a CD-ROM or other computer-readable medium (e.g., readable by a general or special purpose computing system or device), or delivered (e.g., encoded in a propagated signal) over a communication medium of a network to a tangible, non-transitory medium of a computing system where it is executed. Some or all of the processing may be performed on a special purpose computer, or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is preferably stored on or downloaded to a computer-readable storage medium (e.g., solid state memory or media, or magnetic or optical media) of a storage device accessible by a general or special purpose programmable computer, for configuring and operating the computer when the storage device medium is read by the computer to perform the processing described herein. The inventive system may also be considered to be implemented as a tangible, non-transitory medium, configured with a computer program, where the medium so configured causes a computer to operate in a specific and predefined manner to perform one or more of the processing steps described herein.

While this specification includes many specific implementation details, these should not be construed as limitations on the scope of any embodiments or of what may be claimed, but rather as descriptions of features specific to embodiments. Similarly, while operations are depicted in the drawings in a particular order, this should not be understood as requiring that such operations be performed in the order shown or in sequential order, or that all illustrated operations be performed, to achieve desirable results. Moreover, the separation of various system components in the embodiments described above should not be understood as requiring such separation in all embodiments, and the described program components and systems can generally be integrated together in a single software product or packaged into multiple software products.

Several embodiments have been described. Nevertheless, it will be understood that various modifications may be made without departing from the scope of the techniques described herein. For example, some of the steps described above may be order independent, and thus can be performed in an order different from that described. Additionally, any of the foregoing techniques described regarding a dataflow graph can also be implemented and executed regarding a program. Accordingly, other embodiments are within the scope of the following claims.

What is claimed is:

1. A method implemented by a data processing system for processing records with an executable dataflow graph by transmitting the records over a dataflow of the dataflow graph and by transmitting, among the records, information, associated with the processing of the records, over the same dataflow without modifying the records, the method including:
accessing, by the data processing system, the dataflow graph having nodes and edges, with each node specifying computer-executable code for executing one or more processes and with each edge specifying dataflow between two or more of the nodes, wherein a first node of the nodes is configured to transmit data to a second node of the nodes;
processing, by the first node of the dataflow graph, a record in accordance with a process specified by computer-executable code specified by the first node;
based on the processing, producing, by the first node, a processed record to be transmitted to the second node, wherein the first node is configured to transmit records in an order to the second node, with the processed record being at a location in the order;
based on the processing, identifying, by the first node, information associated with processing of the processed record;
associating, by the first node, the identified information with the processed record by:
determining a value specifying the location of the processed record in the order; and
updating the identified information with the value; and
transmitting, by the first node to the second node, a plurality of records including the processed record in the specified location in the order and the updated information among the records in the plurality, by, for each of the records:
identifying a location of the record among the records in the plurality;
determining whether the record is the processed record associated with the updated information by determining whether the identified location corresponds to the value, specifying the location of the processed record, in the updated information; and
when the identified location corresponds to the value in the updated information,
transmitting, over a dataflow specified by an edge from the first node to the second node, the record to the second node at the location in the order; and
transmitting, over the same dataflow to the second node, the updated information in proximity to the transmitted record.

2. The method of claim 1, further including:
receiving, at the first node, a set of records to be processed;
storing in a first buffer, for the set of records, a set of data items, a data item of the set of data items including information associated with a record of the set of records, the data item of the set of data items including a count indicating the record associated with the data item; and
storing the set of records in a second buffer.

3. The method of claim 2, further including:
for processing a particular record of the set of records:
determining, for the particular record, whether a data item in the first buffer includes a particular count that associates the data item with the particular record; and
when the first buffer includes the data item having the particular count associated with the particular record,
processing the particular record by the first node, and
updating the data item based on processing the particular record by the first node; and
when the first buffer does not include the data item having the particular count associated with the particular record,
processing the particular record by the first node, and
generating a new data item based on processing the particular record by the first node for being associated with the particular record.

4. The method of claim 1, further including:
storing, at a first output buffer, the processed record among a set of output records;
determining an output order count for the processed record for being output among the set of output records;
associating the updated information with the output order count for the processed record; and
storing, a at second output buffer, the updated information and the output order count among other updated information for other output records.

5. The method of claim 4, wherein transmitting, over the same dataflow to the second node, the updated information in proximity to the processed record includes transmitting the updated information based on the output order count associated with the updated information.

6. The method of claim 1, wherein transmitting, over the same dataflow to the second node, the updated information in proximity to the transmitted record comprises transmitted the updated information immediately prior to the transmitted record on the same dataflow.

7. The method of claim 1, wherein transmitting, over the same dataflow to the second node, the updated information in proximity to the transmitted record comprises transmitted the updated information immediately subsequent to the transmitted record on the same dataflow.

8. The method of claim 1, further including:
determining that the second node of the dataflow graph is a final node of the dataflow graph without additional nodes; and
transmitting the updated information to a publisher system.

9. The method of claim 1, further including:
determining that the second node of the dataflow graph is a final node of the dataflow graph without additional nodes; and
storing the plurality of records in a data store.

10. The method of claim 1, wherein the updated information is interleaved within the records of the plurality such that the updated information is transmitted in the dataflow between two consecutive data records.

11. The method of claim 1, wherein the updated information associated with the processed record includes trace data describing how the first node processed the processed record.

12. The method of claim 1, wherein the updated information associated with the processed record includes metadata describing a location for a service call by one or more nodes of the dataflow graph.

13. The method of claim 1, wherein the second node is configured to receive additional records from a third node over a different dataflow and additional information associated with the additional records over the different dataflow.

14. The method of claim 13, wherein the second node selects either the additional information or the updated information for associating with processed records of the third node.

15. The method of claim 13, wherein the second node selects both the additional information and the updated information for associating with processed records of the third node.

16. The method of claim 1, wherein the processing, by the first node of the dataflow graph, of the record in accordance with the process specified by computer-executable code encapsulated by the first node is performed to obtain the processed record.

17. The method of claim 1, wherein the updated information associated with the processed record includes one or more values specifying one or more data processing parameters to be used by the second node for defining a portion of processing, by the second node, of the processed record.

18. The method of claim 1, wherein the updated information associated with the processed record includes diagnostic information indicating a performance metric of the first node when processing the processed data record.

19. The method of claim 1, further comprising:
processing, by the second node of the dataflow graph, the transmitted processed record in accordance with a process specified by computer-executable code specified by the second node,
wherein, as the second node processes the processed data record, the second node reads parameter values from the transmitted updated information for processing the processed data record in accordance with the read parameter values.

20. The method of claim 19, further including:
updating the information associated with the processed record in accordance with the processing of the processed record by the second node.

21. The method of claim 20, wherein the information updated in accordance with the processing of the processed record by the second node specifies a time of processing of the processed record at the second node and/or identifies the second node as last node that processed the processed record.

22. A data processing system including a memory and one or more processors for performing operations comprising.
accessing, by the data processing system, a dataflow graph having nodes and edges, with each node specifying computer-executable code for executing one or more processes and with each edge specifying dataflow between two or more of the nodes, wherein a first node of the nodes is configured to transmit data to a second node of the nodes;
processing, by the first node of the dataflow graph, a record in accordance with a process specified by computer-executable code specified by the first node;
based on the processing, producing, by the first node, a processed record to be transmitted to the second node, wherein the first node is configured to transmit records in an order to the second node, with the processed record being at a location in the order;
based on the processing, identifying, by the first node, information associated with processing of the processed record;
associating, by the first node, the identified information with the processed record by:
determining a value specifying the location of the processed record in the order; and
updating the identified information with the value; and
transmitting, by the first node to the second node, a plurality of records including the processed record in the specified location in the order and the updated information among the records in the plurality, by, for each of the records:
identifying a location of the record among the records in the plurality;
determining whether the record is the processed record associated with the updated information by determining whether the identified location corresponds to the value, specifying the location of the processed record, in the updated information; and
when the identified location corresponds to the value in the updated information,
transmitting, over a dataflow specified by an edge from the first node to the second node, the record to the second node at the location in the order; and
transmitting, over the same dataflow to the second node, the updated information in proximity to the transmitted record.

23. The data processing system of claim 22, the operations further including:
receiving, at the first node, a set of records to be processed;
storing in a first buffer, for the set of records, a set of data items, a data item of the set of data items including information associated with a record of the set of records, the data item of the set of data items including a count indicating the record associated with the data item; and
storing the set of records in a second buffer.

24. The data processing system of claim 23, the operations further including:
for processing a particular record of the set of records:
determining, for the particular record, whether a data item in the first buffer includes a particular count that associates the data item with the particular record; and
when the first buffer includes the data item having the particular count associated with the particular record,
processing the particular record by the first node, and
updating the data item based on processing the particular record by the first node; and
when the first buffer does not include the data item having the particular count associated with the particular record,
processing the particular record by the first node, and
generating a new data item based on processing the particular record by the first node for being associated with the particular record.

25. The data processing system of claim 22, the operations further including:
storing, at a first output buffer, the processed record among a set of output records;
determining an output order count for the processed record for being output among the set of output records;
associating the updated information with the output order count for the processed record; and
storing, a at second output buffer, the updated information and the output order count among other updated information for other output records.

26. One or more non-transitory computer-readable hardware storage devices storing instructions that, when executed by one or more processors, enable the one or more processors to perform operations comprising:
accessing a dataflow graph having nodes and edges, with each node specifying computer-executable code for executing one or more processes and with each edge specifying dataflow between two or more of the nodes, wherein a first node of the nodes is configured to transmit data to a second node of the nodes;
processing, by the first node of the dataflow graph, a record in accordance with a process specified by computer-executable code specified by the first node;
based on the processing, producing, by the first node, a processed record to be transmitted to the second node, wherein the first node is configured to transmit records in an order to the second node, with the processed record being at a location in the order;
based on the processing, identifying, by the first node, information associated with processing of the processed record;
associating, by the first node, the identified information with the processed record by:
determining a value specifying the location of the processed record in the order; and
updating the identified information with the value; and
transmitting, by the first node to the second node, a plurality of records including the processed record in the specified location in the order and the updated information among the records in the plurality, by, for each of the records:
identifying a location of the record among the records in the plurality;
determining whether the record is the processed record associated with the updated information by determining whether the identified location corresponds to the value, specifying the location of the processed record, in the updated information; and
when the identified location corresponds to the value in the updated information,
transmitting, over a dataflow specified by an edge from the first node to the second node, the record to the second node at the location in the order; and
transmitting, over the same dataflow to the second node, the updated information in proximity to the transmitted record.
